(19) United States
(12) Patent Application Publication
(10) Pub. No.: US 2022/0398466 A1
(43) Pub. Date: Dec. 15, 2022

(54) System, Method, and Computer Program Product for Event Forecasting Using Graph Theory Based Machine Learning

(71) Applicant: Visa International Service Association, San Francisco, CA (US)

(72) Inventors: Yuhang Wu, Santa Clara, CA (US); Linyun He, Austin, TX (US); Mengting Gu, Stanford, CA (US); Lan Wang, Sunnyvale, CA (US); Shubham Agrawal, Round Rock, TX (US); Yu-San Lin, San Francisco, CA (US); Ishita Bindlish, Austin, TX (US); Fei Wang, Fremont, CA (US); Hao Yang, San Jose, CA (US)

(21) Appl. No.: 17/836,249

(22) Filed: Jun. 9, 2022

Related U.S. Application Data
(60) Provisional application No. 63/209,036, filed on Jun. 10, 2021.
(60) Provisional application No. 63/341,606, filed on May 13, 2022.

(51) Int. Cl. G06N 5/02

(52) U.S. Cl. CPC G06N 5/022

(57) ABSTRACT

Provided is a system for event forecasting using a graph-based machine-learning model that includes at least one processor programmed or configured to receive a dataset of data instances, where each data instance comprises a time series of data points, detect a plurality of motifs representing a plurality of events in the dataset of data instances using a matrix profile-based motif detection technique, generate a bipartite graph representation of the plurality of motifs in a time sequence, and generate a machine-learning model based on the bipartite graph representation of the plurality of motifs in the time sequence, where the machine-learning model is configured to provide an output and the output includes a prediction of whether an event will occur during a specified time interval. Methods and computer program products are also provided.

### CROSS-REFERENCE TO RELATED APPLICATIONS

This application claims the benefit of U.S. Provisional Patent Application No. 63/209,036, filed Jun. 10, 2021, and U.S. Provisional Patent Application No. 63/341,606, filed May 13, 2022, which are incorporated by reference herein in their entireties.

### BACKGROUND

### 1. Field

The present disclosure relates generally to systems, devices, products, apparatus, and methods for event forecasting and, in one particular embodiment or aspect, to a system, product, and method for event forecasting using a graph-based machine-learning model.

### 2. Technical Considerations

A multivariate time series may refer to a time series that has more than one time-dependent variable. In some instances, in a multivariate time series, each time-dependent variable may depend not only on that time-dependent variable's past values, which may be analyzed as events, but the time-dependent variable may also depend on other time-dependent variables. The dependency may be used for forecasting future values of the time-dependent variable.

However, when analyzing a multivariate time series, prediction techniques that are based on true values of time-dependent variables in the multivariate time series may not be able to effectively analyze multiple events inside of a time interval. Further, such prediction techniques may not be able to provide an effective explanation on what events led to an anomaly event.

### SUMMARY

Accordingly, systems, devices, products, apparatus, and/or methods for event forecasting using a graph-based machine-learning model are disclosed that overcome some or all of the deficiencies of the prior art.

According to some non-limiting embodiments or aspects, provided is a system for event forecasting using a graph-based machine-learning model. The system includes at least one processor programmed or configured to receive a dataset of data instances, wherein each data instance includes a time series of data points. The at least one processor is further programmed or configured to detect a plurality of motifs representing a plurality of events in the dataset of data instances using a matrix profile-based motif detection technique. The at least one processor is further programmed or configured to generate a bipartite graph representation of the plurality of motifs in a time sequence. When generating the bipartite graph representation of the plurality of motifs, the at least one processor is programmed or configured to determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence. The at least one processor is further programmed or configured to generate a machine-learning model based on the bipartite graph representation of the plurality of motifs in the time sequence. The machine-learning model is configured to provide an output, and the output includes a prediction of whether an event will occur during a specified time interval.

In some non-limiting embodiments or aspects, the at least one processor may be further programmed or configured to perform an anomaly detection process based on the prediction of whether an event will occur during a specified time interval. The at least one processor may be further programmed or configured to calculate an anomaly score for an entity based on the anomaly detection process.

In some non-limiting embodiments or aspects, the machine-learning model may be configured to provide the output based on an input, and the input may include one or more time series of data points.

In some non-limiting embodiments or aspects, when detecting the plurality of motifs representing the plurality of events in the dataset of data instances using the matrix profile-based motif detection technique, the at least one processor may be programmed or configured to determine a matrix profile score for each data instance of the dataset of data instances, and detect the plurality of motifs representing the plurality of events in the dataset of data instances based on the matrix profile score for each data instance of the dataset of data instances.

In some non-limiting embodiments or aspects, the at least one processor may be further programmed or configured to train the machine-learning model. When training the machine-learning model, the at least one processor may be programmed or configured to determine whether the prediction of whether the event will occur during the specified time interval corresponds to ground truth data indicating whether the event did occur during the specified time interval, and update weight parameters of the machine-learning model based on determining whether the prediction of whether the event will occur at the specified time interval corresponds to ground truth data indicating whether the event did occur at the specified time interval.

In some non-limiting embodiments or aspects, when detecting the plurality of motifs representing the plurality of events in the dataset of data instances using the matrix profile-based motif detection technique, the at least one processor may be programmed or configured to detect each motif of the plurality of motifs according to a plurality of time intervals in which the plurality of motifs are located using the matrix profile-based motif detection technique. When generating the bipartite graph representation of the plurality of motifs in the time sequence, the at least one processor may be programmed or configured to generate the bipartite graph representation of the plurality of motifs in the time sequence based on the plurality of time intervals in which the plurality of motifs are located.

In some non-limiting embodiments or aspects, the plurality of nodes of the bipartite graph representation further may include two nodes representative of residual error. A first node of the two nodes may indicate whether the residual error in the time series of data points is larger than a threshold, and a second node of the two nodes may indicate whether the residual error is equal to or less than the threshold. The at least one processor may be further programmed or configured to calculate an anomaly score based on at least one of the following: an event forecasting score based on a probability value of at least one signal pattern in the bipartite graph representation; a residual score based on a frequency of change of at least one signal pattern in the bipartite graph representation; or any combination thereof.

According to some non-limiting embodiments or aspects, provided is a computer-implemented method for event forecasting using a graph-based machine-learning model. The method includes receiving, with at least one processor, a dataset of data instances, wherein each data instance includes a time series of data points. The method further includes detecting, with at least one processor, a plurality of motifs representing a plurality of events in the dataset of data instances using a matrix profile-based motif detection technique. The method further includes generating, with at least one processor, a bipartite graph representation of the plurality of motifs in a time sequence, wherein generating the bipartite graph representation of the plurality of motifs includes: determining, with at least one processor, a plurality of features representing a plurality of nodes of the bipartite graph representation based on each event of the plurality of events represented by the plurality of motifs, and determining, with at least one processor, a plurality of features representing a plurality of edges of the bipartite graph representation based on a time at which each event of the plurality of events represented by the plurality of motifs occurred in the time sequence. The method further includes generating, with at least one processor, a machine-learning model based on the bipartite graph representation of the plurality of motifs in the time sequence, wherein the machine-learning model is configured to provide an output, and wherein the output includes a prediction of whether an event will occur during a specified time interval.

In some non-limiting embodiments or aspects, the method further includes performing, with at least one processor, an anomaly detection process based on the prediction of whether an event will occur during a specified time interval.

In some non-limiting embodiments or aspects, the method further includes calculating, with at least one processor, an anomaly score for an entity based on the anomaly detection process.

In some non-limiting embodiments or aspects, the machine-learning model is configured to provide the output based on an input, and the input includes one or more time series of data points.

In some non-limiting embodiments or aspects, detecting the plurality of motifs representing the plurality of events in the dataset of data instances using the matrix profile-based motif detection technique includes: determining, with at least one processor, a matrix profile score for each data instance of the dataset of data instances, and detecting, with at least one processor, the plurality of motifs representing the plurality of events in the dataset of data instances based on the matrix profile score for each data instance of the dataset of data instances.

In some non-limiting embodiments or aspects, the method further includes training, with at least one processor, the machine-learning model. Training the machine-learning model includes determining, with at least one processor, whether the prediction of whether the event will occur during the specified time interval corresponds to ground truth data indicating whether the event did occur during the specified time interval, and updating, with at least one processor, weight parameters of the machine-learning model based on determining whether the prediction of whether the event will occur at the specified time interval corresponds to ground truth data indicating whether the event did occur at the specified time interval.

In some non-limiting embodiments or aspects, detecting the plurality of motifs representing the plurality of events in the dataset of data instances using the matrix profile-based motif detection technique includes detecting, with at least one processor, each motif of the plurality of motifs according to a plurality of time intervals in which the plurality of motifs are located using the matrix profile-based motif detection technique. Generating the bipartite graph representation of the plurality of motifs in the time sequence includes generating, with at least one processor, the bipartite graph representation of the plurality of motifs in the time sequence based on the plurality of time intervals in which the plurality of motifs are located.

In some non-limiting embodiments or aspects, the plurality of nodes of the bipartite graph representation further include at least one residual node associated with a residual error.

In some non-limiting embodiments or aspects, the at least one residual node includes a first residual node and a second residual node, wherein the first residual node indicates the residual error is larger than a threshold, and wherein the second residual node indicates the residual error is equal to or less than the threshold.

In some non-limiting embodiments or aspects, the method further includes calculating, with at least one processor, an anomaly score based on at least one of the following: an event forecasting score based on a probability value of at least one signal pattern in the bipartite graph representation, a residual score based on a frequency of change of at least one signal pattern in the bipartite graph representation, or any combination thereof.

According to some non-limiting embodiments or aspects, provided is a computer program product for event forecasting using a graph-based machine-learning model. The computer program product includes at least one non-transitory computer-readable storage medium including program instructions that, when executed by at least one processor, cause the at least one processor to receive a dataset of data instances, wherein each data instance includes a time series of data points. The program instructions also cause the at least one processor to detect a plurality of motifs representing a plurality of events in the dataset of data instances using a matrix profile-based motif detection technique. The program instructions further cause the at least one processor to generate a bipartite graph representation of the plurality of motifs in a time sequence. When generating the bipartite graph representation of the plurality of motifs, the program instructions cause the at least one processor to: determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence. The program instructions further cause the at least one processor to generate a machine-learning model based on the bipartite graph representation of the plurality of motifs in the time sequence, wherein the machine-learning model is configured to provide an output, and wherein the output includes a prediction of whether an event will occur during a specified time interval.

In some non-limiting embodiments or aspects, the program instructions further cause the at least one processor to perform an anomaly detection process based on the prediction of whether an event will occur during a specified time interval.

In some non-limiting embodiments or aspects, the program instructions further cause the at least one processor to calculate an anomaly score for an entity based on the anomaly detection process.

In some non-limiting embodiments or aspects, the machine-learning model is configured to provide the output based on an input, wherein the input includes one or more time series of data points.

In some non-limiting embodiments or aspects, when detecting the plurality of motifs representing the plurality of events in the dataset of data instances using the matrix profile-based motif detection technique, the program instructions cause the at least one processor to: determine a matrix profile score for each data instance of the dataset of data instances; and detect the plurality of motifs representing the plurality of events in the dataset of data instances based on the matrix profile score for each data instance of the dataset of data instances.

In some non-limiting embodiments or aspects, the program instructions further cause the at least one processor to train the machine-learning model. When training the machine-learning model, the program instructions cause the at least one processor to: determine whether the prediction of whether the event will occur during the specified time interval corresponds to ground truth data indicating whether the event did occur during the specified time interval. In some non-limiting embodiments or aspects, the program instructions further cause the at least one processor to update weight parameters of the machine-learning model based on determining whether the prediction of whether the event will occur at the specified time interval corresponds to ground truth data indicating whether the event did occur at the specified time interval.

In some non-limiting embodiments or aspects, when detecting the plurality of motifs representing the plurality of events in the dataset of data instances using the matrix profile-based motif detection technique, the program instructions cause the at least one processor to detect each motif of the plurality of motifs according to a plurality of time intervals in which the plurality of motifs are located using the matrix profile-based motif detection technique. In some non-limiting embodiments or aspects, when generating the bipartite graph representation of the plurality of motifs in the time sequence, the program instructions cause the at least one processor to generate the bipartite graph representation of the plurality of motifs in the time sequence based on the plurality of time intervals in which the plurality of motifs are located.

In some non-limiting embodiments or aspects, the plurality of nodes of the bipartite graph representation further include at least one residual node associated with a residual error.

In some non-limiting embodiments or aspects, the at least one residual node includes a first residual node and a second residual node, wherein the first residual node indicates the residual error is larger than a threshold, and wherein the second residual node indicates the residual error is equal to or less than the threshold.

In some non-limiting embodiments or aspects, the program instructions further cause the at least one processor to calculate an anomaly score based on at least one of the following: an event forecasting score based on a probability value of at least one signal pattern in the bipartite graph representation, a residual score based on a frequency of change of at least one signal pattern in the bipartite graph representation, or any combination thereof.

Further non-limiting embodiments or aspects are set forth in the following numbered clauses:

Clause 1: A system for event forecasting using a graph-based machine-learning model, the system comprising: at least one processor programmed or configured to: receive a dataset of data instances, wherein each data instance comprises a time series of data points; detect a plurality of motifs representing a plurality of events in the dataset of data instances using a matrix profile-based motif detection technique; generate a bipartite graph representation of the plurality of motifs in a time sequence, wherein, when generating the bipartite graph representation of the plurality of motifs, the at least one processor is programmed or configured to: determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence; and generate a machine-learning model based on the bipartite graph representation of the plurality of motifs in the time sequence, wherein the machine-learning model is configured to provide an output, and wherein the output comprises a prediction of whether an event will occur during a specified time interval.

Clause 2: The system of clause 1, wherein the at least one processor is further programmed or configured to: perform an anomaly detection process based on the prediction of whether an event will occur during a specified time interval.

Clause 3: The system of clause 1 or clause 2, wherein the at least one processor is further programmed or configured to: calculate an anomaly score for an entity based on the anomaly detection process.

Clause 4: The system of any of clauses 1-3, wherein the machine-learning model is configured to provide the output based on an input, and wherein the input comprises one or more time series of data points.

Clause 5: The system of any of clauses 1-4, wherein, when detecting the plurality of motifs representing the plurality of events in the dataset of data instances using the matrix profile-based motif detection technique, the at least one processor is programmed or configured to: determine a matrix profile score for each data instance of the dataset of data instances; and detect the plurality of motifs representing the plurality of events in the dataset of data instances based on the matrix profile score for each data instance of the dataset of data instances.

Clause 6: The system of any of clauses 1-5, wherein the at least one processor is further programmed or configured to: train the machine-learning model, wherein, when training the machine-learning model, the at least one processor is programmed or configured to: determine whether the prediction of whether the event will occur during the specified time interval corresponds to ground truth data indicating whether the event did occur during the specified time interval; and update weight parameters of the machine-learning model based on determining whether the prediction of whether the event will occur at the specified time interval corresponds to ground truth data indicating whether the event did occur at the specified time interval.

Clause 7: The system of any of clauses 1-6, wherein, when detecting the plurality of motifs representing the plurality of events in the dataset of data instances using the matrix profile-based motif detection technique, the at least one processor is programmed or configured to: detect each motif of the plurality of motifs according to a plurality of time intervals in which the plurality of motifs are located using the matrix profile-based motif detection technique; and wherein, when generating the bipartite graph representation of the plurality of motifs in the time sequence, the at least one processor is programmed or configured to: generate the bipartite graph representation of the plurality of motifs in the time sequence based on the plurality of time intervals in which the plurality of motifs are located.

Clause 8: The system of any of clauses 1-7, wherein the plurality of nodes of the bipartite graph representation further comprise at least one residual node associated with a residual error.

Clause 9: The system of any of clauses 1-8, wherein the at least one residual node comprises a first residual node and a second residual node, wherein the first residual node indicates the residual error is larger than a threshold, and wherein the second residual node indicates the residual error is equal to or less than the threshold.

Clause 10: The system of any of clauses 1-9, wherein the at least one processor is further programmed or configured to calculate an anomaly score based on at least one of the following: an event forecasting score based on a probability value of at least one signal pattern in the bipartite graph representation, a residual score based on a frequency of change of at least one signal pattern in the bipartite graph representation, or any combination thereof.

Clause 11: A computer-implemented method for event forecasting using a graph-based machine-learning model, comprising: receiving, with at least one processor, a dataset of data instances, wherein each data instance comprises a time series of data points; detecting, with at least one processor, a plurality of motifs representing a plurality of events in the dataset of data instances using a matrix profile-based motif detection technique; generating, with at least one processor, a bipartite graph representation of the plurality of motifs in a time sequence, wherein generating the bipartite graph representation of the plurality of motifs comprises: determining, with at least one processor, a plurality of features representing a plurality of nodes of the bipartite graph representation based on each event of the plurality of events represented by the plurality of motifs, and determining, with at least one processor, a plurality of features representing a plurality of edges of the bipartite graph representation based on a time at which each event of the plurality of events represented by the plurality of motifs occurred in the time sequence; and generating, with at least one processor, a machine-learning model based on the bipartite graph representation of the plurality of motifs in the time sequence, wherein the machine-learning model is configured to provide an output, and wherein the output comprises a prediction of whether an event will occur during a specified time interval.

Clause 12: The method of clause 11, further comprising: performing, with at least one processor, an anomaly detection process based on the prediction of whether an event will occur during a specified time interval.

Clause 13: The method of clause 11 or clause 12, further comprising: calculating, with at least one processor, an anomaly score for an entity based on the anomaly detection process.

Clause 14: The method of any of clauses 11-13, wherein the machine-learning model is configured to provide the output based on an input, and wherein the input comprises one or more time series of data points.

Clause 15: The method of any of clauses 11-14, wherein detecting the plurality of motifs representing the plurality of events in the dataset of data instances using the matrix profile-based motif detection technique comprises: determining, with at least one processor, a matrix profile score for each data instance of the dataset of data instances; and detecting, with at least one processor, the plurality of motifs representing the plurality of events in the dataset of data instances based on the matrix profile score for each data instance of the dataset of data instances.

Clause 16: The method of any of clauses 11-15, further comprising: training, with at least one processor, the machine-learning model, wherein training the machine-learning model comprises: determining, with at least one processor, whether the prediction of whether the event will occur during the specified time interval corresponds to ground truth data indicating whether the event did occur during the specified time interval; and updating, with at least one processor, weight parameters of the machine-learning model based on determining whether the prediction of whether the event will occur at the specified time interval corresponds to ground truth data indicating whether the event did occur at the specified time interval.

Clause 17: The method of any of clauses 11-16, wherein detecting the plurality of motifs representing the plurality of events in the dataset of data instances using the matrix profile-based motif detection technique comprises: detecting, with at least one processor, each motif of the plurality of motifs according to a plurality of time intervals in which the plurality of motifs are located using the matrix profile-based motif detection technique; and wherein generating the bipartite graph representation of the plurality of motifs in the time sequence comprises: generating, with at least one processor, the bipartite graph representation of the plurality of motifs in the time sequence based on the plurality of time intervals in which the plurality of motifs are located.

Clause 18: The method of any of clauses 11-17, wherein the plurality of nodes of the bipartite graph representation further comprise at least one residual node associated with a residual error.

Clause 19: The method of any of clauses 11-18, wherein the at least one residual node comprises a first residual node and a second residual node, wherein the first residual node indicates the residual error is larger than a threshold, and wherein the second residual node indicates the residual error is equal to or less than the threshold.

Clause 20: The method of any of clauses 11-19, further comprises calculating, with at least one processor, an anomaly score based on at least one of the following: an event forecasting score based on a probability value of at least one signal pattern in the bipartite graph representation, a residual score based on a frequency of change of at least one signal pattern in the bipartite graph representation, or any combination thereof.

Clause 21: A computer program product for event forecasting using a graph-based machine-learning model, the computer program product comprising at least one non-transitory computer-readable storage medium comprising program instructions that, when executed by at least one processor, cause the at least one processor to: receive a dataset of data instances, wherein each data instance comprises a time series of data points; detect a plurality of motifs representing a plurality of events in the dataset of data instances using a matrix profile-based motif detection technique; generate a bipartite graph representation of the plurality of motifs in a time sequence, wherein, when generating the bipartite graph representation of the plurality of motifs, the program instructions cause the at least one processor to: determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence; and generate a machine-learning model based on the bipartite graph representation of the plurality of motifs in the time sequence, wherein the machine-learning model is configured to provide an output, and wherein the output comprises a prediction of whether an event will occur during a specified time interval.

Clause 22: The computer program product of clause 21, wherein the program instructions further cause the at least one processor to perform an anomaly detection process based on the prediction of whether an event will occur during a specified time interval.

Clause 23: The computer program product of clause 21 or clause 22, wherein the program instructions further cause the at least one processor to calculate an anomaly score for an entity based on the anomaly detection process.

Clause 24: The computer program product of any of clauses 21-23, wherein the machine-learning model is configured to provide the output based on an input, and wherein the input comprises one or more time series of data points.

Clause 25: The computer program product of any of clauses 21-24, wherein, when detecting the plurality of motifs representing the plurality of events in the dataset of data instances using the matrix profile-based motif detection technique, the program instructions cause the at least one processor to: determine a matrix profile score for each data instance of the dataset of data instances; and detect the plurality of motifs representing the plurality of events in the dataset of data instances based on the matrix profile score for each data instance of the dataset of data instances.

Clause 26: The computer program product of any of clauses 21-25, wherein the program instructions further cause the at least one processor to train the machine-learning model, wherein, when training the machine-learning model, the program instructions cause the at least one processor to: determine whether the prediction of whether the event will occur during the specified time interval corresponds to ground truth data indicating whether the event did occur during the specified time interval; and update weight parameters of the machine-learning model based on determining whether the prediction of whether the event will occur at the specified time interval corresponds to ground truth data indicating whether the event did occur at the specified time interval.

Clause 27: The computer program product of any of clauses 21-26, wherein, when detecting the plurality of motifs representing the plurality of events in the dataset of data instances using the matrix profile-based motif detection technique, the program instructions cause the at least one processor to: detect each motif of the plurality of motifs according to a plurality of time intervals in which the plurality of motifs are located using the matrix profile-based motif detection technique; and wherein, when generating the bipartite graph representation of the plurality of motifs in the time sequence, the program instructions cause the at least one processor to: generate the bipartite graph representation of the plurality of motifs in the time sequence based on the plurality of time intervals in which the plurality of motifs are located.

Clause 28: The computer program product of any of clauses 21-27, wherein the plurality of nodes of the bipartite graph representation further comprise at least one residual node associated with a residual error.

Clause 29: The computer program product of any of clauses 21-28, wherein the at least one residual node comprises a first residual node and a second residual node, wherein the first residual node indicates the residual error is larger than a threshold, and wherein the second residual node indicates the residual error is equal to or less than the threshold.

Clause 30: The computer program product of any of clauses 21-29, wherein the program instructions further cause the at least one processor to calculate an anomaly score based on at least one of the following: an event forecasting score based on a probability value of at least one signal pattern in the bipartite graph representation, a residual score based on a frequency of change of at least one signal pattern in the bipartite graph representation, or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Additional advantages and details of the present disclosure are explained in greater detail below with reference to the exemplary embodiments that are illustrated in the accompanying schematic figures, in which:

FIG. 1A is a diagram of a non-limiting embodiment or aspect of an environment in which systems, devices, products, apparatus, and/or methods, described herein, may be implemented according to the principles of the present disclosure;

FIG. 1B is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1A and/or FIG. 1B;

FIG. 3 is a flowchart of a non-limiting embodiment or aspect of a process for event forecasting using a graph-based machine-learning model;

FIG. 4A is an implementation of a non-limiting embodiment or aspect of a process for event forecasting using a graph-based machine-learning model;

FIG. 4B is a flowchart of a non-limiting embodiment or aspect of a process for event forecasting using a graph-based machine-learning model;

FIG. 5 is a flowchart of a non-limiting embodiment or aspect of a process for event forecasting using a graph-based machine-learning model;

FIG. 6 is a schematic diagram of a non-limiting embodiment or aspect of a process for event forecasting using a graph-based machine-learning model;

FIG. 7 is a schematic diagram of a non-limiting embodiment or aspect of a process for event forecasting using a graph-based machine-learning model;

FIG. 8 is a set of illustrative time series graphs of a non-limiting embodiment or aspect of a process for event forecasting using a graph-based machine-learning model;

FIG. 9 is an illustrative anomaly score graph of a non-limiting embodiment or aspect of a process for event forecasting using a graph-based machine-learning model;

FIG. 10 is a diagram of a non-limiting embodiment or aspect of a process for detecting time-series motifs from multivariate time-series data;

FIG. 11 is a diagram of a non-limiting embodiment or aspect of a process for event forecasting using a graph-based machine-learning model;

FIG. 12 is a diagram of an experimental application of a non-limiting embodiment or aspect a process for event forecasting using a graph-based machine-learning model; and

FIG. 13 is a diagram of an experimental application of a non-limiting embodiment or aspect a process for event forecasting using a graph-based machine-learning model.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer. An “application” or “application program interface” (API) may refer to computer code or other data sorted on a computer-readable medium that may be executed by a processor to facilitate the interaction between software components, such as a client-side front-end and/or server-side back-end for receiving data from the client. An “interface” may refer to a generated display, such as one or more graphical user interfaces (GUIs) with which a user may interact, either directly or indirectly (e.g., through a keyboard, mouse, etc.).

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or client devices.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present disclosure are directed to systems, methods, and computer program products for event forecasting using a graph-based machine-learning model. In some non-limiting embodiments or aspects, an event graph management system may include at least one processor programmed or configured to receive a dataset of data instances, wherein each data instance comprises a time series of data points. The at least one processor may be further programmed or configured to detect a plurality of motifs representing a plurality of events in the dataset of data instances using a matrix profile-based motif detection technique. The at least one processor may be further programmed or configured to generate a bipartite graph representation of the plurality of motifs in a time sequence. For example, when generating the bipartite graph representation of the plurality of motifs, the at least one processor may be programmed or configured to determine a plurality of features representing a plurality of nodes of the bipartite graph representation based on each event of the plurality of events represented by the plurality of motifs, and/or determine a plurality of features representing a plurality of edges of the bipartite graph representation based on a time at which each event of the plurality of events represented by the plurality of motifs occurred in the time sequence. The at least one processor may be further programmed or configured to generate a machine-learning model based on the bipartite graph representation of the plurality of motifs in the time sequence. For example, the machine-learning model may be configured to provide an output, and/or the output may include a prediction of whether an event will occur during a specified time interval. In this way, the event graph management system may provide for accurately analyzing multiple events of a multivariate time series inside of a time interval and provide the ability to learn events that led to an anomaly event. Furthermore, by generating a graph representation of the plurality of motifs, the event graph management system may reduce the amount of computer memory resources used for analysis of the graph representation (e.g., particularly by reducing the node-to-node edge complexity of the underlying model) and provides flexibility for performing analysis as compared to analyzing multiple events of the multivariate time series in a raw data format.

Disclosed systems and methods provide an improved process for anomaly detection from multivariate time series. The multivariate time series may include multiple univariate time series from a same entity. A multivariate time series X may be defined as follows:

X∈ [symbol] ^{T×d}, Formula 1

where [symbol] is real numbers, T is the maximum number of time intervals in the time series, and d is the dimension. The disclosed event detection processes may detect events (e.g., anomalies) at specific time steps \dot{t}* (e.g., a point in time), which may be represented as:

\dot{t}*∈ [symbol] Formula 2

The detection of events may be at specific time steps in a multivariate time series where the time-series behavior deviates from the normal patterns of the time series. Set [symbol] for example, may contain timestamps that were marked as anomalies by a domain expert.

In scenarios where T is large (e.g., a long time series), a sliding interval approach (called, e.g., a sliding window approach) may be employed. In such scenarios, anomaly detection may be formulated as a binary classification problem with the objective to identify time intervals according to the following formula:

X^{[\dot{t}-τ:t]×d}, Formula 3

where τ denotes the length of the sliding time interval, and t denotes a time step.

The disclosed dynamic bipartite design for analyzing multivariate time series reduces the complexity of training, testing, and executing the underlying machine-learning model by decoupling three concepts of event graphs: where (e.g., in what time series), when (e.g., at what time), and which (e.g., from what event category). Decoupling these concepts avoids the problem of exponential pattern combinations of other predictive models.

In some non-limiting embodiments or aspects, the disclosed techniques may make use of a dynamic bipartite graph. The dynamic bipartite graph may be defined as a sequence of undirected bipartite event graphs:

[symbol]

_{B}^{t}={(vₘ^{t},vₑ^{t},A(vₘ^{t},vₑ^{t}))}, Formula 4

where t represents when the time interval of an event graph is formulated (in view of the further notation of Formulas 5, 6, and 7, below). For example, if the time interval size is set to be 1, then the time interval t may be the same as the time step \dot{t}. In the disclosed bipartite graph representation, a time-series node may be formulated as:

vₘ^{t}, Formula 5

which indicates where (e.g., in what time series m at a time t) an event is happening, and an event node may be formulated as:

vₑ^{t}, Formula 6

which represents a signal pattern (e.g., an event e) in a segment of time t of a time series.

Time-series nodes and event nodes may be connected in the graph representation by attributed edges. An attributed edge may be formulated as:

A(vₘ^{t},vₑ^{t}). Formula 7

An attributed edge may connect an event node and a time-series node and may indicate that an event node happened on time series m at time interval t. For simplicity, the attributed edge may also be denoted as A_{m,e}. The disclosed systems and methods may employ an edge stream representation so that an edge is constructed to represent the relation that actually existed. A benefit of using an edge stream representation is that it allows the graph structure to be more scalable and flexible for system deployment, which allows the system to incorporate new events that have not appeared in training. The foregoing bipartite graph representation, including the use of time-series nodes and event nodes, are further described in relation to the systems and methods, below.

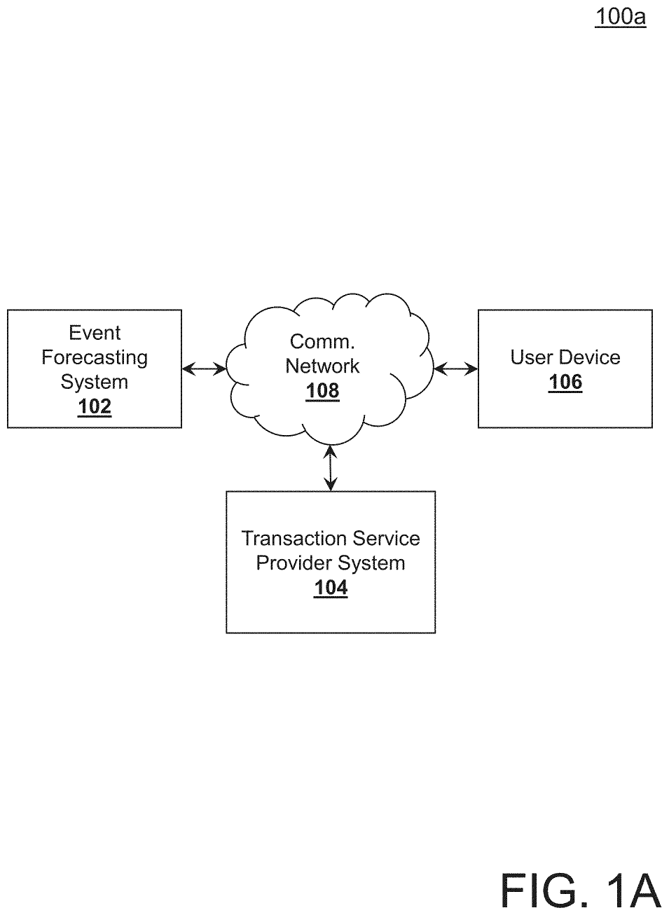

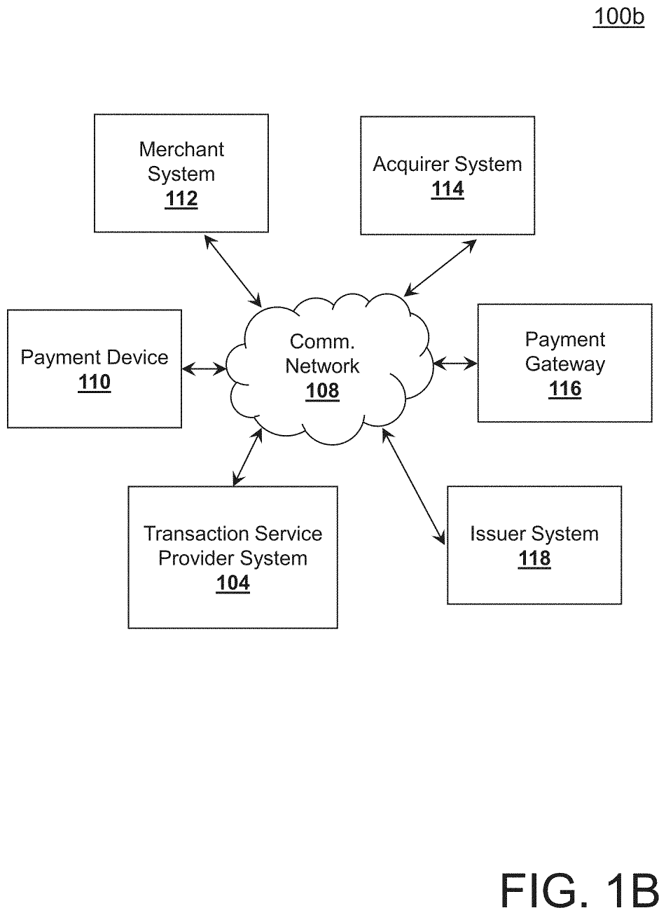

Referring now to FIG. 1A, FIG. 1A is a diagram of an example environment 100a in which devices, systems, and/or methods, described herein, may be implemented. As shown in FIG. 1A, environment 100a may include event forecasting system 102, transaction service provider system 104, user device 106, and communication network 108. Event forecasting system 102, transaction service provider system 104, and/or user device 106 may interconnect (e.g., establish a connection to communicate) via wired connections, wireless connections, or a combination of wired and wireless connections.

Event forecasting system 102 may include one or more devices configured to communicate with transaction service provider system 104 and/or user device 106 via communication network 108. For example, event forecasting system 102 may include a server, a group of servers, and/or other like devices. In some non-limiting embodiments or aspects, event forecasting system 102 may be associated with a transaction service provider, as described herein. Additionally or alternatively, event forecasting system 102 may generate (e.g., train, validate, retrain, and/or the like), store, and/or implement (e.g., operate, provide inputs to and/or outputs from, and/or the like) one or more machine-learning models. In some non-limiting embodiments or aspects, event forecasting system 102 may be in communication with a data storage device, which may be local or remote to event forecasting system 102. In some non-limiting embodiments or aspects, event forecasting system 102 may be capable of receiving information from, storing information in, transmitting information to, and/or searching information stored in the data storage device.

Transaction service provider system 104 may include one or more devices configured to communicate with event forecasting system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider, as discussed herein. In some non-limiting embodiments or aspects, time series analysis system may be a component of transaction service provider system 104. In some non-limiting embodiments or aspects, event forecasting system 102 and transaction service provider system 104 may be part of the same system (e.g., event forecasting system 102 may be part of transaction service provider system 104 and/or the like).

User device 106 may include a computing device configured to communicate with event forecasting system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual operating user device 106). In some non-limiting embodiments or aspects, user device 106 may be associated with a transaction service provider (e.g., part of transaction service provider system 104), as discussed herein. In some non-limiting embodiments or aspects, user device 106 may be associated with a merchant (e.g., a merchant system), an acquirer (e.g., an acquirer system), an issuer (e.g., an issuer system) and/or the like.

Communication network 108 may include one or more wired and/or wireless networks. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

With continued reference to FIG. 1A, event forecasting system 102 may receive a dataset of data instances, wherein each data instance includes a time series of data points. In some non-limiting embodiments or aspects, the dataset may include transaction time-series data from a plurality of transactions processed by transaction service provider system 104.

Event forecasting system 102 may detect a plurality of motifs representing a plurality of events in the dataset of data instances using a matrix profile-based motif detection technique. Event forecasting system 102 may, to detect said plurality of motifs, determine a matrix profile score for each data instance of the dataset of data instances and detect the plurality of motifs representing the plurality of events in the dataset of data instances based on the matrix profile score for each data instance of the dataset of data instances. In some non-limiting embodiments or aspects, event forecasting system 102 may, when detecting the plurality of motifs, detect each motif according to one or more time intervals in which the motifs are located using the matrix profile-based motif detection technique. Furthermore, event forecasting system 102 may generate the bipartite graph representation based on the one or more time intervals in which the motifs are located.

Event forecasting system 102 may generate a bipartite graph representation of the plurality of motifs in a time sequence. To generate the bipartite graph representation, event forecasting system 102 may determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence. The plurality of nodes of the bipartite graph representation may include at least one residual node associated with a residual error. The at least one residual node may include a first residual node that indicates the residual error is larger than a threshold, and a second residual node that indicates the residual error is equal to or less than the threshold.

Event forecasting system 102 may generate a machine-learning model based on the bipartite graph representation of the plurality of motifs in the time sequence. The machine-learning model may be configured to provide an output, which may be a prediction of whether an event will occur during a specified time interval.

Event forecasting system 102 may train the machine-learning model by determining whether the prediction of whether the event will occur corresponds to ground truth data indicating whether the event did occur during the specified time interval, and update weight parameters of the machine-learning model based on said determination.

Event forecasting system 102 may further perform an anomaly detection process based on the prediction of whether an event will occur during a specified time interval. Event forecasting system 102 may calculate an anomaly score for an entity based on the anomaly detection process. The anomaly score may be further based on an event forecasting score, based on a probability value of at least one signal pattern in the bipartite graph representation, and a residual score based on a frequency of change of at least one signal pattern in the bipartite graph representation, or any combination thereof.

The number and arrangement of devices and networks shown in FIG. 1A are provided as an example. There may be additional devices and/or networks, fewer devices and/or networks, different devices and/or networks, or differently arranged devices and/or networks than those shown in FIG. 1A. Furthermore, two or more devices shown in FIG. 1A may be implemented within a single device, or a single device shown in FIG. 1A may be implemented as multiple, distributed devices. Additionally or alternatively, a set of devices (e.g., one or more devices) of environment 100a may perform one or more functions described as being performed by another set of devices of environment 100a.

Referring now to FIG. 1B, FIG. 1B is a diagram of an example environment 100b in which devices, systems, and/or methods, described herein, may be implemented. As shown in FIG. 1B, environment 100b may include transaction service provider system 104, payment device 110, merchant system 112, acquirer system 114, payment gateway 116, issuer system 118, and communication network 108. Transaction service provider system 104, payment device 110, merchant system 112, acquirer system 114, payment gateway 116, and/or issuer system 118 may interconnect (e.g., establish a connection to communicate) via wireless connections, wireless connections, or a combination of wired and wireless connections.

Payment device 110 may include a computing device configured to communicate with merchant system 112 via communication network 108. For example, payment device 110 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, payment device 110 may be associated with a payment device holder (e.g., a user). Payment device 110 may communicate with merchant system 112 by transmitting payment device data (e.g., payment device identifier) to complete transactions from an account of a payment device holder to an account of a merchant of merchant system 112.

Merchant system 112 may include a computing device configured to communicate with payment device 110, acquirer system 114, and/or payment gateway 116 via communication network 108. For example, merchant system 112 may include a point-of-sale (POS) system, which may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. Merchant system 112 may communicate with payment device 110 by receiving payment device data to complete transactions from an account of a payment device holder to an account of a merchant of the merchant system 112. Merchant system 112 may further communicate with acquirer system 114 and/or payment gateway 116 by transmitting transaction data (e.g., transaction description, transaction time, transaction amount, payment device identifier, merchant identifier, etc.) for processing of a transaction, e.g., in the form of a transaction authorization request.

Acquirer system 114 may include a computing device configured to communicate with merchant system 112, payment gateway 116, issuer system 118, and/or transaction service provider system 104 via communication network 108. For example, acquirer system 114 may communicate with merchant system 112 by receiving transaction data (e.g., transaction description, transaction time, transaction amount, payment device identifier, merchant identifier, etc.) for processing of a transaction in the form of a transaction authorization request. Acquirer system 114 may communicate with transaction service provider system 104, directly or indirectly through payment gateway 116, to cause a transaction to be processed by transmitting transaction data to the transaction service provider system 104, e.g., in the form of a transaction authorization request. Acquirer system 114 may communicate with issuer system 118, directly or indirectly through transaction service provider system 104, to transfer funds for a processed transaction from an account of the payment device holder to an account of the merchant.

Payment gateway 116 may include a computing device configured to communicate with merchant system 112, acquirer system 114, issuer system 118, and/or transaction service provider system 104 via communication network 108. For example, payment gateway 116 may communicate with merchant system 112 by receiving transaction data (e.g., transaction description, transaction time, transaction amount, payment device identifier, merchant identifier, etc.) for processing of a transaction in the form of a transaction authorization request, on behalf of acquirer system 114. Payment gateway 116 may communicate with transaction service provider system 104 to cause a transaction to be processed by transmitting transaction data to the transaction service provider system 104, e.g., in the form of a transaction authorization request. Payment gateway 116 may communicate with issuer system 118, on behalf of acquirer system 114, directly or indirectly through transaction service provider system 104, to transfer funds for a processed transaction from an account of the payment device holder to an account of the merchant.

Issuer system 118 may include a computing device configured to communicate with payment device 110, acquirer system 114, payment gateway 116, and/or transaction service provider system 104 via communication network 108. For example, issuer system 118 may issue credentials for payment device 110 and communicate account data and/or payment device data associated with the payment device 110 to the payment device 110. By way of further example, issuer system 118 may communicate with acquirer system 114, indirectly or directly through a payment gateway 116 and/or transaction service provider system 104, to transfer funds for a processed transaction from an account of the payment device holder to an account of the merchant.

The number and arrangement of devices and networks shown in FIG. 1B are provided as an example. There may be additional devices and/or networks, fewer devices and/or networks, different devices and/or networks, or differently arranged devices and/or networks than those shown in FIG. 1B. Furthermore, two or more devices shown in FIG. 1B may be implemented within a single device, or a single device shown in FIG. 1B may be implemented as multiple, distributed devices. Additionally or alternatively, a set of devices (e.g., one or more devices) of environment 100a and/or environment 100b may perform one or more functions described as being performed by another set of devices of environment 100a and/or environment 100b.

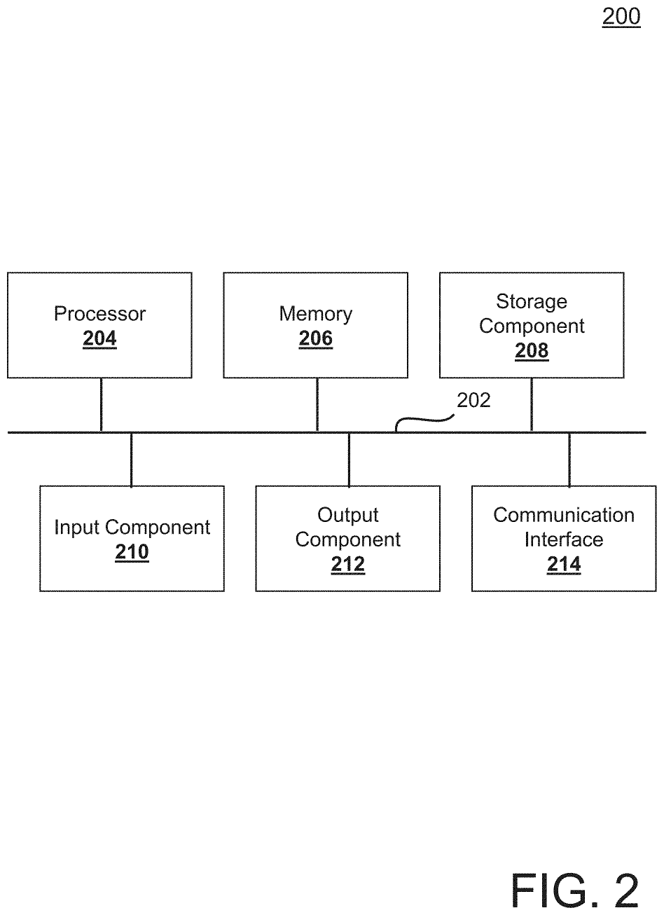

Referring now to FIG. 2, FIG. 2 is a diagram of example components of a device 200. Device 200 may correspond to event forecasting system 102 (e.g., one or more devices of event forecasting system 102), transaction service provider system 104 (e.g., one or more devices of transaction service provider system 104), user device 106, payment device 110, merchant system 112 (e.g., one or more devices of merchant system 112), acquirer system 114 (e.g., one or more devices of acquirer system 114), payment gateway 116 (e.g., one or more devices of payment gateway 116), and/or issuer system 118 (e.g., one or more devices of issuer system 118). In some non-limiting embodiments or aspects, event forecasting system 102, transaction service provider system 104, user device 106, payment device 110, merchant system 112, acquirer system 114, payment gateway 116, and/or issuer system 118 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device may include memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

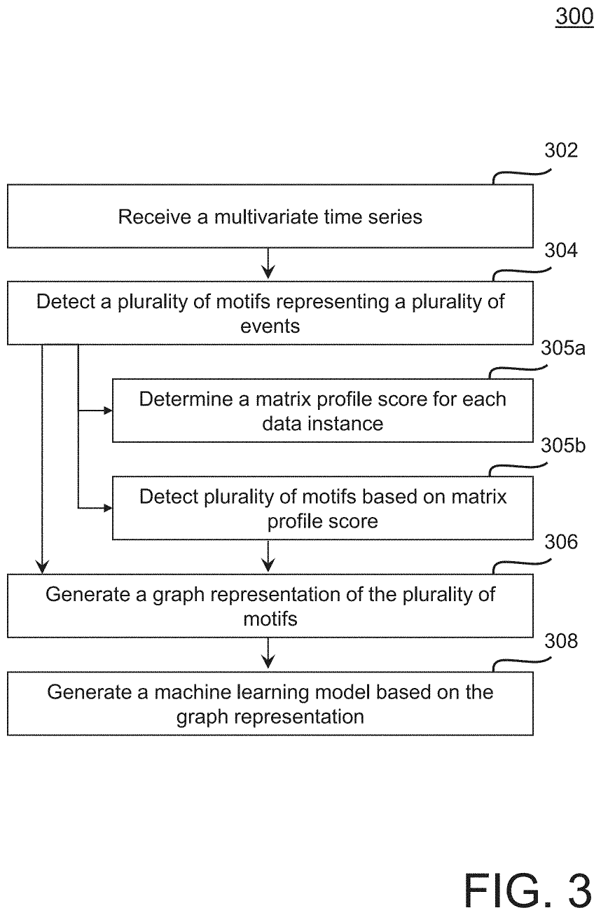

Referring now to FIG. 3, FIG. 3 is a flowchart of a non-limiting embodiment or aspect of a process 300 for event forecasting using a graph-based machine-learning model. In some non-limiting embodiments or aspects, one or more of the steps of process 300 may be performed (e.g., completely, partially, etc.) by event forecasting system 102 (e.g., one or more devices of event forecasting system 102). In some non-limiting embodiments or aspects, one or more of the steps of process 300 may be performed (e.g., completely, partially, etc.) by another device or a group of devices separate from or including event forecasting system 102 (e.g., one or more devices of event forecasting system 102), transaction service provider system 104 (e.g., one or more devices of transaction service provider system 104), and/or user device 106. The steps shown in FIG. 3 are for example purposes only. It will be appreciated that additional, fewer, different, and/or a different order of steps may be used in non-limiting embodiments or aspects.

As shown in FIG. 3, at step 302, process 300 may include receiving a multivariate time series. For example, event forecasting system 102 may receive the multivariate time series. In some non-limiting embodiments or aspects, event forecasting system 102 may receive a dataset that includes a plurality of data instances. Each data instance may include a time series, such as a multivariate time series, of data points. A multivariate time series may be partitioned into a plurality of univariate time series for input into a machine-learning model described herein, for testing, training, and/or implementation.

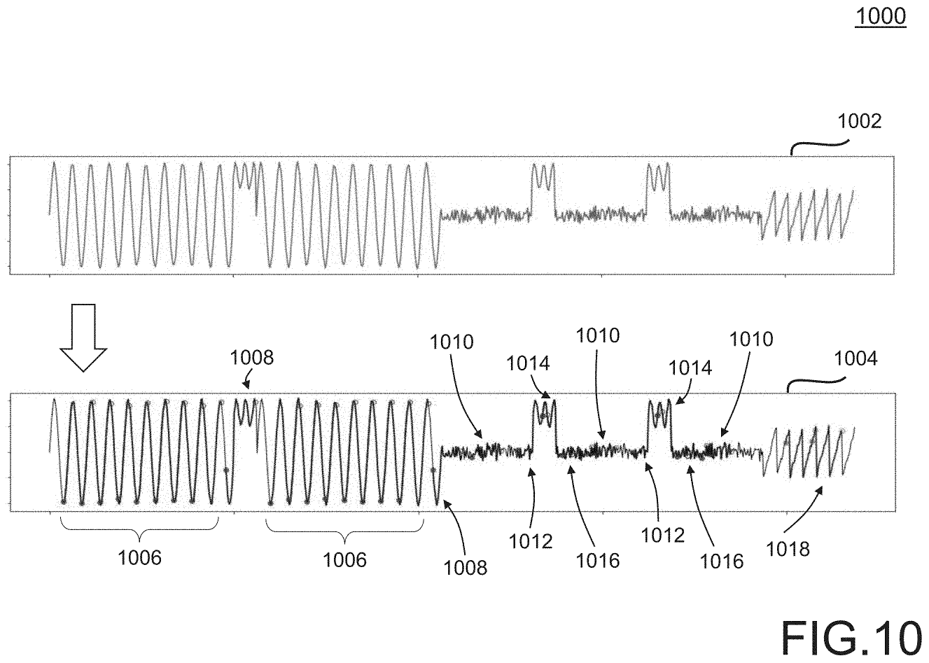

As shown in FIG. 3, at step 304, process 300 may include detecting a plurality of motifs representing a plurality of events. For example, event forecasting system 102 may detect the plurality of motifs representing the plurality of events. In some non-limiting embodiments or aspects, event forecasting system 102 may detect the plurality of motifs in the dataset of data instances using a matrix profile-based motif detection technique (e.g., as illustrated and described further in connection with FIG. 10).

In some non-limiting embodiments or aspects, process 300 may include, at step 305a, determining a matrix profile score for each data instance. For example, event forecasting system 102 may determine a matrix profile score for each data instance of the dataset of data instances. In some non-limiting embodiments or aspects, process 300 may include, at step 305b, detecting a plurality of motifs based on a matrix profile score. For example, event forecasting system 102 may detect the plurality of motifs representing the plurality of events in the dataset of data instances based on the matrix profile score for each data instance of the dataset of data instances. In some non-limiting embodiments or aspects, event forecasting system 102 may detect each motif of the plurality of motifs according to a plurality of time intervals in which the plurality of motifs are located using the matrix profile-based motif detection technique. For example, a motif may be detected by employing a pattern recognition technique to identify similar changes in variable value (e.g., signal over time) across multiple univariate time series.

As shown in FIG. 3, at step 306, process 300 may include generating a graph representation of the plurality of motifs. For example, event forecasting system 102 may generate the graph representation of the plurality of motifs. In some non-limiting embodiments or aspects, event forecasting system 102 may generate a bipartite graph representation of the plurality of motifs in a time sequence. In some non-limiting embodiments or aspects, when generating the bipartite graph representation of the plurality of motifs, event forecasting system 102 may determine a plurality of features representing a plurality of nodes of the bipartite graph representation based on each event of the plurality of events represented by the plurality of motifs, and determine a plurality of features representing a plurality of edges of the bipartite graph representation based on a time at which each event of the plurality of events represented by the plurality of motifs occurred in the time sequence.

In some non-limiting embodiments or aspects, event forecasting system 102 may generate the bipartite graph representation of the plurality of motifs in the time sequence based on the plurality of time intervals in which the plurality of motifs are located.

As shown in FIG. 3, at step 308, process 300 may include generating a machine-learning model based on the graph representation. For example, event forecasting system 102 may generate a machine-learning model based on the graph representation, e.g., by applying the machine-learning model on top of the graph representation. In some non-limiting embodiments or aspects, event forecasting system 102 may generate a machine-learning model based on a bipartite graph representation of the plurality of motifs in the time sequence.

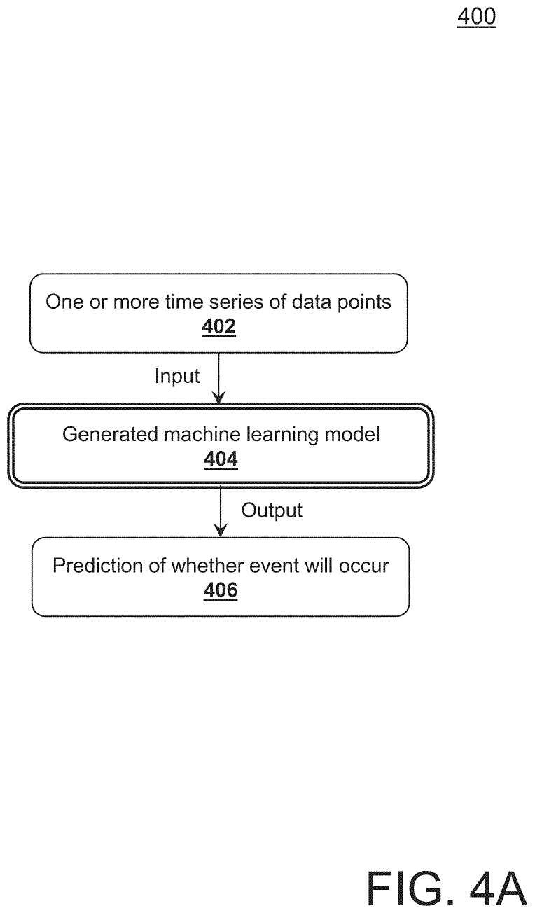

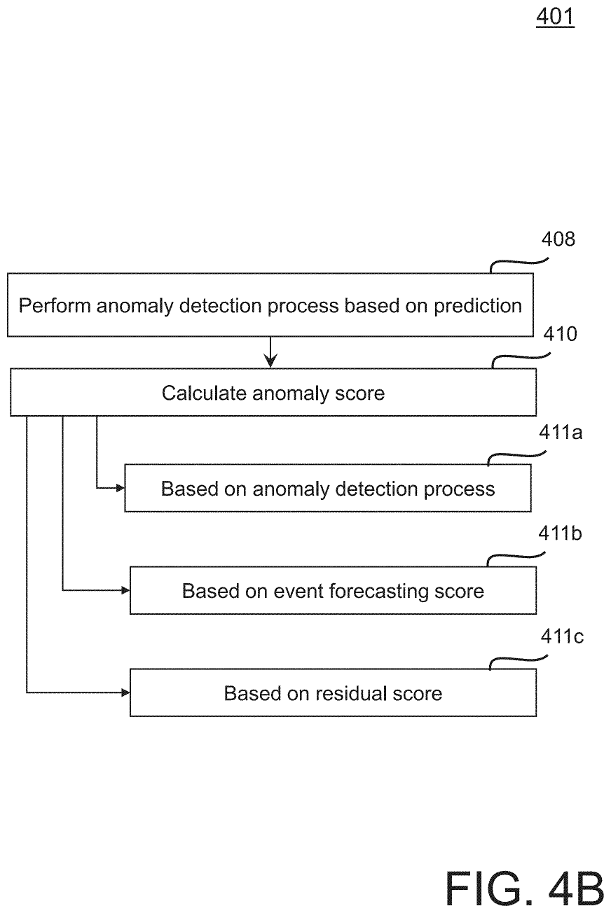

Referring now to FIG. 4A, FIG. 4A is an implementation 400 of a non-limiting embodiment or aspect of a method for event forecasting using a graph-based machine-learning model. In some non-limiting embodiments or aspects, a process executing the implementation 400 may be performed (e.g., completely, partially, etc.) by event forecasting system 102 (e.g., one or more devices of event forecasting system 102). In some non-limiting embodiments or aspects, one or more steps of the process executing the implementation 400 may be performed (e.g., completely, partially, etc.) by another device or a group of devices separate from or including event forecasting system 102 (e.g., one or more devices of event forecasting system 102), transaction service provider system 104 (e.g., one or more devices of transaction service provider system 104), and/or user device 106. In some non-limiting embodiments or aspects, the machine-learning model 404, generated as described herein, may be configured to provide an output 406 that includes a prediction of whether an event will occur during a specified time interval. In some non-limiting embodiments or aspects, the machine-learning model 404 may be configured to provide the output 406 based on an input 402 that includes one or more time series of data points. The output 406 prediction from the machine-learning model 404 may be used in a process 401 for anomaly detection, as illustrated in FIG. 4B.

Referring now to FIG. 4B, FIG. 4B is a flowchart of a non-limiting embodiment or aspect of a process 401 for event forecasting using a graph-based machine-learning model. In some non-limiting embodiments or aspects, one or more of the steps of process 401 may be performed (e.g., completely, partially, etc.) by event forecasting system 102 (e.g., one or more devices of event forecasting system 102). In some non-limiting embodiments or aspects, one or more of the steps of process 401 may be performed (e.g., completely, partially, etc.) by another device or a group of devices separate from or including event forecasting system 102 (e.g., one or more devices of event forecasting system 102), transaction service provider system 104 (e.g., one or more devices of transaction service provider system 104), and/or user device 106. The steps shown in FIG. 4B are for example purposes only. It will be appreciated that additional, fewer, different, and/or a different order of steps may be used in non-limiting embodiments or aspects.

As shown in FIG. 4B, at step 408, process 400 may include performing an anomaly detection process based on the prediction from the output 406. For example, event forecasting system 102 may perform an anomaly detection process based on the prediction of whether an event will occur during a specific time interval. The anomaly detection process may include a comparison between a prediction and an actual observed event. For example, event forecasting system 102 may compare actual, observed time-series data to predicted time-series data to identify anomalies based on the difference(s) between the predicted values and observed values.

As shown in FIG. 4B, at step 410, process 400 may include calculating an anomaly score. For example, event forecasting system 102 may calculate an anomaly score for an entity based on the anomaly detection process. For example, for time-series data that is transaction data processed by a transaction service provider system 104, the anomaly score may be generated for a merchant based on the anomaly detection process, at step 411a. In some non-limiting embodiments or aspects, the calculation of the anomaly score may be based on an event forecasting score (e.g., based on a probability value of at least one signal pattern in the bipartite graph representation, such as shown in Formula 10, below) at step 411b, a residual score (e.g., based on a frequency of change of at least one signal pattern in the bipartite graph representation, such as shown in Formula 11, below) at step 411c, or any combination thereof.

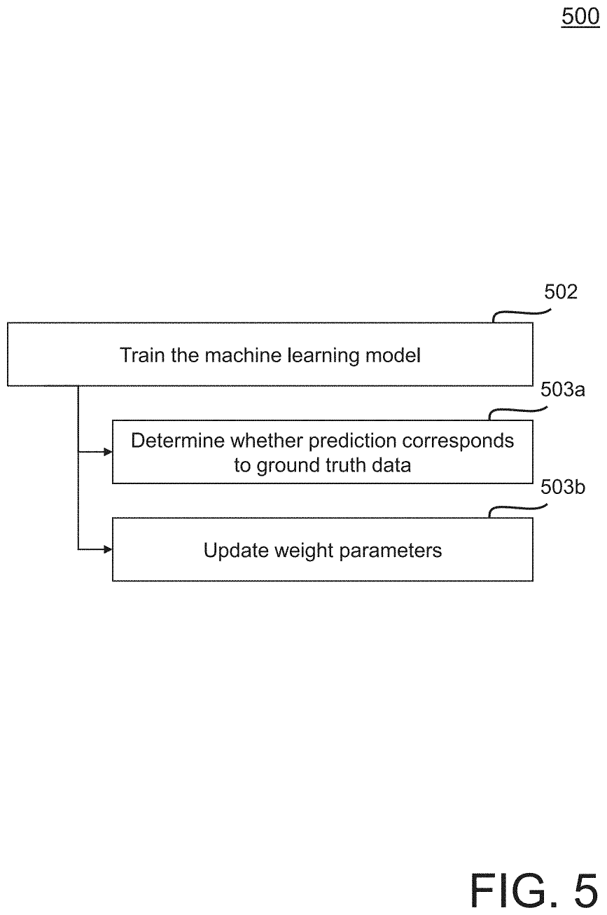

Referring now to FIG. 5, FIG. 5 is a flowchart of a non-limiting embodiment or aspect of a process 500 for event forecasting using a graph-based machine-learning model. In some non-limiting embodiments or aspects, one or more of the steps of process 500 may be performed (e.g., completely, partially, etc.) by event forecasting system 102 (e.g., one or more devices of event forecasting system 102). In some non-limiting embodiments or aspects, one or more of the steps of process 500 may be performed (e.g., completely, partially, etc.) by another device or a group of devices separate from or including event forecasting system 102 (e.g., one or more devices of event forecasting system 102), transaction service provider system 104 (e.g., one or more devices of transaction service provider system 104), and/or user device 106.

As shown in FIG. 5, at step 502, process 500 may include training the machine-learning model. For example, event forecasting system 102 may train the machine-learning model, e.g., by comparing predicted data to observed data. Training the machine-learning model may include, at step 503a, determining whether the prediction corresponds to ground truth data and, at step 503b, updating weight parameters of the machine-learning model based on the determination in step 503a. For example, event forecasting system 102 may determine whether the prediction of whether the event will occur during the specified time interval corresponds to ground truth data indicating whether the event did occur during the specified time interval. Event forecasting system 102 may further update weight parameters of the machine-learning model based on determining whether the prediction of whether the event will occur at the specified time interval corresponds to ground truth data indicating whether the event did occur at the specified time interval.

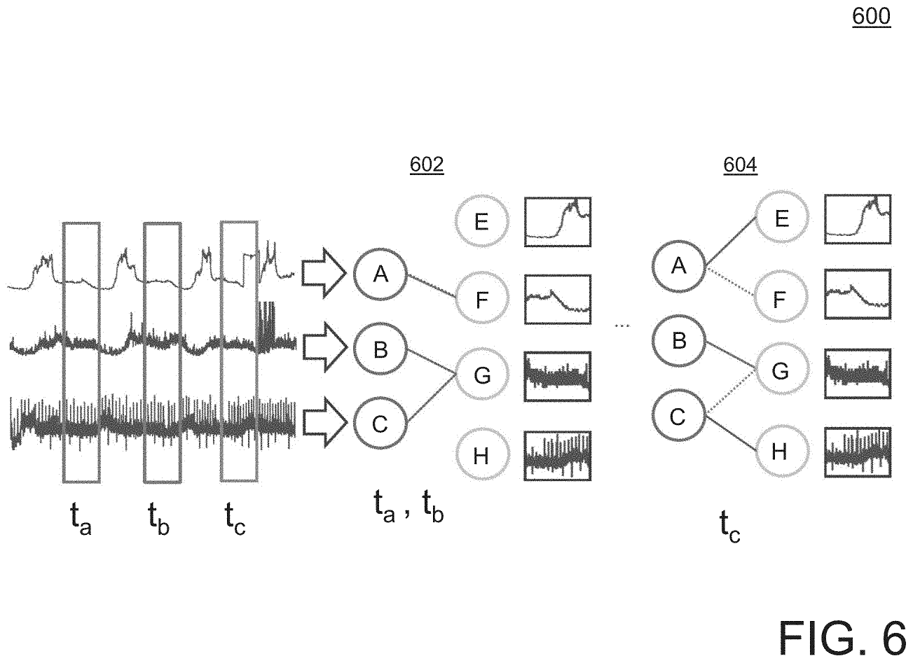

Referring now to FIG. 6, FIG. 6 is a schematic diagram of a non-limiting embodiment or aspect of a process 600 for event forecasting using a graph-based machine-learning model. In particular, process 600 depicts an overview of constructing event-driven bipartite graph representations. Process 600 depicts three rows of time-series data (e.g., each row representing a variable of a multivariate time-series dataset), depicted as parallel signal graphs, each being associated with a respective time-series node A, B, C of the bipartite graph representations 602, 604. Event patterns (e.g., changes in variable value, also referred to as signal, in time segments of a time series, which may be represented by motifs) of the time-series data are associated with event nodes E, F, G, H of the bipartite graph representations 602, 604. The relationship between time-series nodes A, B, C and event nodes E, F, G, H are depicted by way of edges connecting the nodes. An edge connecting a time-series node A, B, C to an event node E, F, G, H may represent that the respective time series associated with the time-series node A, B, C exhibits the motif associated with the event node E, F, G, H. As shown, the green line represents a predicted relationship (e.g., generated by the machine-learning model) between a time-series node A, B, C and an event node E, F, G, H, and the red line depicts an actual relationship (e.g., observed data) between a time-series node A, B, C and an event node E, F, G, H. Where a predicted relationship and an actual relationship coincide, the green and red lines are coextensive, which creates the appearance of a brown line in the drawing.

To address the problem of an exponential number of combinations, the disclosed system and method disentangles the time-series nodes A, B, C and event nodes E, F, G, H into a bipartite graph representation, as shown in FIG. 6. Each event node E, F, G, H represents an event (e.g., one or more changes in variable value in a time segment, which may be represented by a motif) of a time series. A connection between two types of nodes indicates an event e happened on the d^{th} time series at time interval t. The maximum number of edges in the graph may be represented in big O notation as O(KD) (where K is the number of events, e.g., time segment patterns, in each time series, and D is the number of time series), which is much smaller than O(K^{D}) or O(K^{2D}), of prior solutions. Further efficiency and generalizability of the disclosed methods are provided by using edge streams, where connections between nodes are modeled as incoming attributed edges instead of constructing adjacency matrices.

As shown, bipartite graph representations 602, 604 are generated for three intervals of the time-series data. A first bipartite graph representation 602 is shown for time intervals tₐ and t_{b}. The first bipartite graph representation 602 has three time-series nodes A, B, C and four event nodes E, F, G, H. Because the time series associated with time-series node A exhibits an event pattern in time intervals tₐ and t_{b} associated with event node F, the first bipartite graph representation 602 has an edge connecting time-series node A with event node F. Time intervals tₐ and t_{b} exhibit expected event pattern behavior, and so the predicted relationships (green lines) coincide with the actual relationships (red lines). Shown in the first bipartite graph representation 602 are edges representing coinciding predicted and actual relationships between time-series node A and event node F, time-series node B and event node G, and time series C and event node G. Because the event patterns associated with event nodes E and H are not detected in the time series in time intervals tₐ and t_{b}, there are no edges depicting actual relationships (red lines) between any time-series nodes A, B, C, and event nodes E and H.

Also shown is a second bipartite graph representation 604 for time interval t_{c}. The time-series data exhibits anomalous behavior in time interval t_{b} for the time series of time-series node A and the time series of time-series node C. For example, while there was a predicted relationship (green line) between time-series node A and event node F for time interval t_{c}, the actual event pattern of the time series was different, being associated with the event pattern of event node E. Therefore, there is an actual relationship (red line) between time-series node A and event node E. Similarly, while there was a predicted relationship (green line) between time-series node C and event node G for time interval t_{c}, the actual event pattern of the time series was different, being associated with the event pattern of event node H. Therefore, there is an actual relationship (red line) between time-series node C and event node H. In contrast, there was no anomalous behavior in the time series associated with time-series node B. Therefore, the edges depicting actual and predicted relationships coincide in the second bipartite graph representation 604 for time-series node B, the same as in the first bipartite graph representation 602.

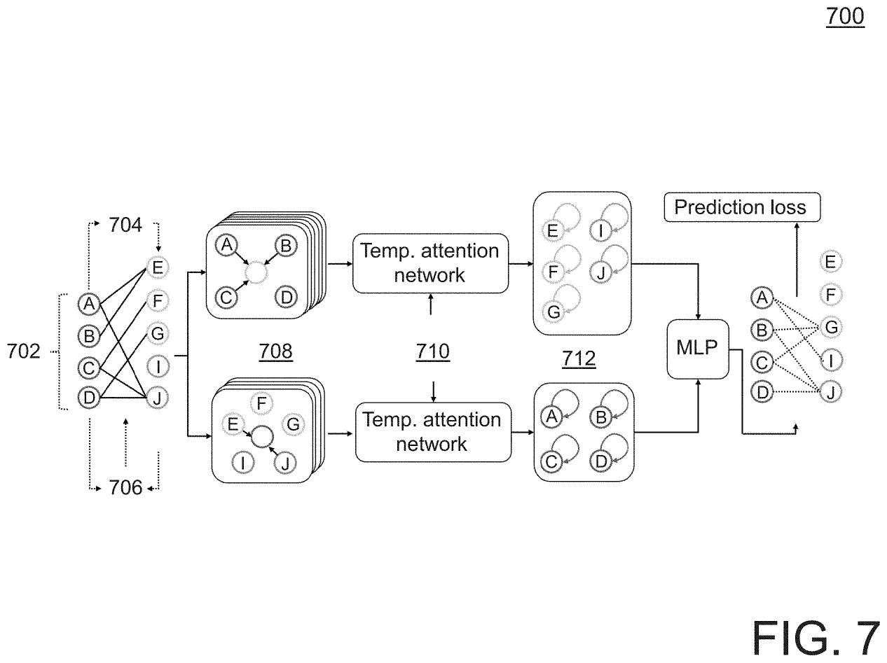

Referring now to FIG. 7, FIG. 7 is a schematic diagram of a non-limiting embodiment or aspect of a process 700 for event forecasting using a graph-based machine-learning model. In particular, process 700 depicts an overview of disclosed systems and methods for predicting events and identifying anomalies in time-series data. As shown, time-series nodes A, B, C, D are represented by blue circles and event nodes E, F, G, I, J are represented by yellow and orange circles. Event nodes resulting from time-series matching are shown as yellow circles (event nodes E, F, G), and event nodes resulting from computation of residual error (e.g., residual nodes) are shown as orange circles (event nodes I, J). One or more steps of process 700 may be executed by one or more systems or devices of an environment 100a, 100b for event forecasting using a graph-based machine-learning model, including, but not limited to, event forecasting system 102 and/or transaction service provider system 104.

Process 700 may include, at step 702, receiving an input of a dataset of data instances, wherein each data instance includes a time series of data points. For example, transaction service provider system 104 may receive the dataset of data instances, such as by processing a plurality of transactions completed between users of payment devices and merchants. Transaction service provider system 104 may transmit the dataset of data instances to the event forecasting system 102. Each individual time series (e.g., a univariate time series of the multivariate time series) of the dataset is associated with a time-series node A, B, C, D.

Process 700 may include, at step 704, detecting a plurality of motifs representing a plurality of events in the dataset of data instances. For example, event forecasting system 102 may detect a plurality of events in the dataset by using a matrix profile-based detection technique. Each motif may represent an event and be associated with event node E, F, G. The matrix profile-based detection technique (e.g., SCRIMP++, and/or the like) may include an unsupervised algorithm to identify representative patterns from time sequences. Matrix profile-based techniques may identify the top-K repeated patterns in time-series data with high accuracy and low computation time. The input of the matrix-profile based detection technique may be a data instance of time-series data (where m is the time series, D is the number of dimensions, and k is the index of a pattern selected from the set of K), and the output of the matrix profile-based detection technique may be a list of single dimensional representative patterns, each with a size r, formulated as follows:

p_{m,k}(m∈{1:D},k∈{1:K}). Formula 8

Process 700 may include, at step 706, detecting anomalies in the time-series data. For example, event forecasting system 102 may perform an anomaly detection process based on the prediction of whether an event will occur during a specified time interval. In doing so, event forecasting system 102 may calculate an anomaly score for an entity based on the anomaly detection process. The anomaly score may be based on an event forecasting score (e.g., based on a probability value of at least one signal pattern in the bipartite graph representation), a residual score (e.g., based on a frequency of change of at least one signal pattern in the bipartite graph representation), or any combination thereof.

Further to step 706, the aforementioned graph-based machine-learning model may be trained in a self-supervised fashion. The model may predict events that might happen in the time intervals in the next time period, which correspond to the edges linking the time-series nodes A, B, C, D and event nodes E, F, G. Therefore, the model may be trained based on the edge prediction task. Prediction loss may be captured by using cross entropy.

To convert the predicted event edges Â into an anomaly score, for each time-series node A, B, C, D with time interval size τ, the event node E, F, G that has the highest probability to connect to the time-series node A, B, C, D may be retrieved and its pattern in the original signal space may be denoted as:

s_{e,τ}^{t}, Formula 9

where t is time step, τ is the length of the time interval, and e is the event index. The event's pattern (formulated above) may be projected back to its original signal space, from which an anomaly score may be computed based on the dynamic time wrapping distance as follows:

ω_{1,m}^{t}(DTW(X_{m,τ}^{t},s_{e,τ}^{t}), Formula 10

which may represent the event forecasting score (wherein, DTW stands for the dynamic time wrapping distance function).

For a positive residual event at time interval t, where the forecasted result is not a positive residual, a changing point score (e.g., residual score) may be calculated to quantify the surprisal level, as follows:

ω_{2,m}^{t}=ψ_{NLG}(∥X_{m,τ}^{t}−X_{m,τ}^{t-τ}∥), Formula 11

where ψ_{NLG} is a function that maps a scalar into the negative log likelihood, which indicates the sparsity of the changing point in the training data. A frequently changing signal may result in a small changing point score after the mapping. The function is learned in a data-driven manner based on the training data of time series m. The final anomaly score at time interval t may then be calculated using, but is not limited to, one of the following equations:

$${ω}_{max}^{t} = {max}_{m} ( {ω}_{1 , m}^{t} \cdot {ω}_{2 , m}^{t} ) , or \qquad Formula 12$$

$${ω}_{sum}^{t} = {\sum }_{m} ( {ω}_{1 , m}^{t} \cdot {ω}_{2 , m}^{t} ) \qquad Formula 13$$

The selection of Formula 12 or Formula 13 may be determined by the property of the anomaly in a testing dataset. For example, if very few (e.g., even a single) time series determine the anomaly labels, then Formula 12 may be employed. If the anomaly score of time t is determined by multiple time series, Formula 13 may be employed.

Process 700 may include, at step 708, a message-passing process, which may be executed by event forecasting system 102. For each pair of time-series node A, B, C, D, and event node E, F, G in the bipartite graph representation, the node features may be defined as vₘ and vₑ, respectively. Edge features between vₘ and vₑ may be defined as ϵ_{m,e}. In order to support dynamic inter-dependency graph, event forecasting system 102 may adopt a state-message framework to model the node interactions. For each time-series node (e.g., a given time-series node m) at time interval t, a state vector may be defined as sₘ(t), to represent its interaction history with other event nodes before time interval tin a compressed format. By initiating sₘ(0) as an all-zero vector, the interaction at time interval t may be encoded with a message vector [symbol] ₘ(t), as follows:

[symbol]

ₘ(t)=[ϵ_{m,e}(t)∥Δt∥sₘ(t⁻)∥sₑ(t⁻)], Formula 14

where Δt is the time elapsed between the previous time interval t⁻ and time interval t, and the symbol ∥ represents the concatenating operation. After aggregating all the messages from neighbors, the state vector of a given time-series node may be updated as:

sₘ(t)=mem(agg{ [symbol] ₘ(t₁), . . . , [symbol] ₘ(t_{b})},sₘ(t⁻)), Formula 15

where agg( ) is an aggregation operation.

Process 700 may include, at step 710, application of a temporal attention network. For example, event forecasting system 102 may build upon the state vectors of the above-described process to generate a time-aware node embedding at any time interval t, as follows:

$${z}_{m} ( t ) = {\sum }_{j ∈ {n}_{m}^{k} ( [ 0 , t ] )} TGA ( {s}_{m} ( t ) , {s}_{e} ( t ) , {e}_{m , e} , {υ}_{m} ( t ) , {υ}_{e} ( t ) ) , \qquad Formula 16$$

where TGA represents a temporal graph attention function, and where L graph attention layers compute the given time-series node m's embedding by aggregating information from its L-hop temporal neighbors. Further to step 708, event forecasting system 102 may use a finite dimensional mapping function to encode the time elapsed between t and t₀ as the functional time encoding: (t−t₀). The time encoding function allows the time elapsed to be encoded with other graph features in an end-to-end manner. In some non-limiting embodiments or aspects, the temporal graph attention function may aggregate information from each node's L-hop temporal neighborhood, according to the following formulation of said aggregation:

hₘ⁽⁰⁾(t)=sₘ(t)+vₘ(t) Formula 17

zₘ(t)=MLP^{(l)}(hₘ^{(l-1)}(t)∥\tilde{h}ₘ^{(l)}(t))=hₘ^{(l)}(t), Formula 18

where l is the index of the L^{th} layer, h represents the aggregate information, MLP is a model layer perceptron (MLP) process, and z is the value of the activation of the hidden layer for the MLP process.

Process 700 may include, at step 712, a node-level gated recurrent unit (GRU) update process. For example, event forecasting system 102 may, in each layer of the temporal graph attention model, use multi-head-attention, where a node attends to its neighboring nodes, generating key, query, and values based on neighboring nodes' representations and the encoded time elapses. After temporal graph attention, event forecasting system 102 may execute a MLP process (e.g., as described above). For example, event forecasting system 102 may integrate the reference node representations with the aggregated information, according to the following formulas:

\tilde{h}ₘ^{(l)}(t)=MultiHeadAttention^{(l)}(q^{(l)}(t),K^{(l)}(t),V^{(l)}(t)), Formula 19

q^{(l)}(t)=hᵢ^{(l-1)}(t)∥ϕ(0), Formula 20

K^{(l)}(t)=V^{(l)}(t))=[hₑ_{₁}^{(l-1)}(t)∥∈_{m,e}_{₁}(t₁)∥ϕ(t−t₁), . . . , hₑ_{_{N}}^{(l-1)}(t)f∥∈_{m,e}_{_{N}}(t_{N})∥ϕ(t−t_{N})], Formula 21

where ϕ is the activation function (e.g., sigmoid logistic function) of the MLP process, MultiHeadAttention is the multi-head-attention function described in Vaswani et al.'s paper, Attention is All You Need, 31st Conference on Neural Information Processing Systems (2017) (incorporated by reference herein in its entirety), q is a query of the matrix Q of the MultiHeadAttention process, k is a key of the matrix K of the MultiHeadAttention process, vis a value of the matrix V of the MultiHeadAttention process, and f is attention pooling of the MultiHeadAttention process.

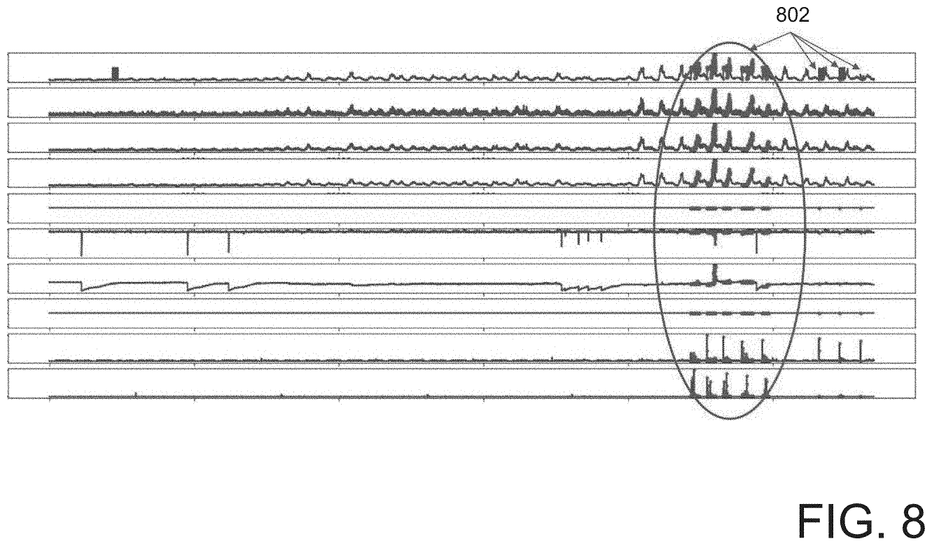

Referring now to FIG. 8, FIG. 8 is a set of illustrative time series graphs of a non-limiting embodiment or aspect of a method for event forecasting using a graph-based machine-learning model. Depicted are ten graphs of a multivariate time series in parallel (e.g., each graph representing a univariate time series thereof), sharing a same x-axis. The x-axis represents time and the y-axis for each graph represents a dependent variable value of the time series (e.g., normalized for readability, such as having a value between 0 and 1). Signal data of the time-series data is shown in blue. Ground truth data identifying anomalous events are highlighted in red. Ground truth data may be input using a user device 106 and may be provided by a domain expert, e.g., a trained user. Ground truth data may also be automatically determined through observed event activity. As described herein, time-series data, such as depicted in FIG. 8, may be input to a trained machine-learning model to compute anomaly scores of the events occurring in various time intervals of the time-series data.

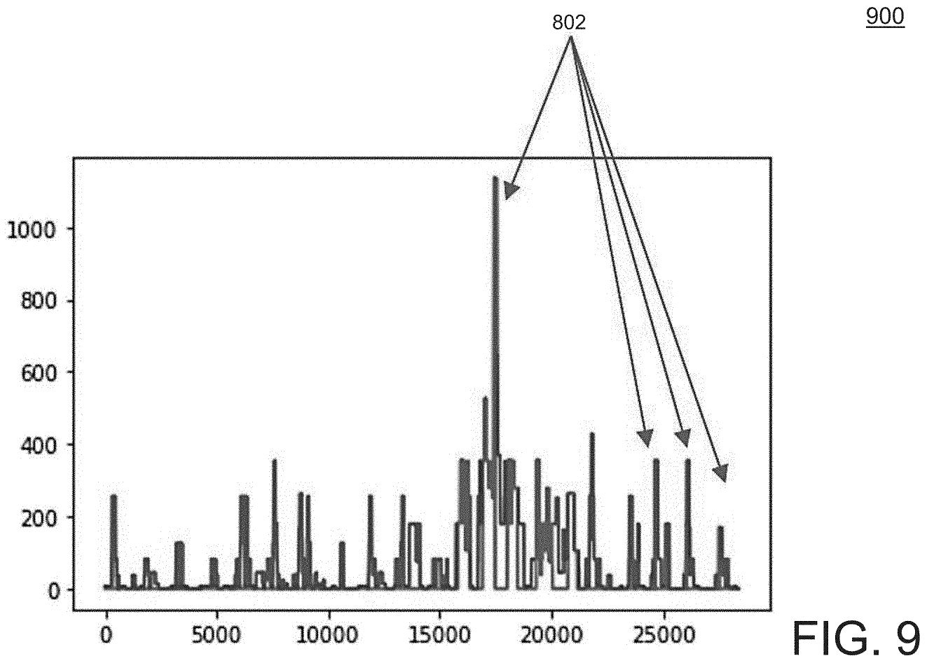

Referring now to FIG. 9, FIG. 9 is an illustrative anomaly score graph of a non-limiting embodiment or aspect of a process for event forecasting using a graph-based machine-learning model. Time-series data, e.g., such as shown in FIG. 8, may be input to the trained machine-learning model. The machine-learning model may then calculate anomaly scores for the events occurring in various time intervals of the time-series data. For example, as shown, the anomaly score graph has an x-axis of time (e.g., units of time, such as 0-25,000 seconds, minutes, etc.), and a y-axis of anomaly score. Predicted anomaly scores for time intervals are shown in blue, and ground truth scores for actual anomalous events are shown in red. A well-performing model may generate predicted anomaly scores similar to the ground truth anomaly scores, such that events that are non-anomalous according to the ground truth data may have lower (e.g., closer to zero) anomaly scores, and events that are anomalous according to the ground truth data may have higher anomaly scores.

Referring now to FIG. 10, FIG. 10 is a diagram 1000 of a non-limiting embodiment or aspect of a process for event forecasting using a graph-based machine-learning model. In particular, diagram 1000 shows two time series graphs 1002, 1004 for comparison, including a first graph 1002 depicting the time-series data without motifs identified, and a second graph 1004 depicting the time-series data with motifs identified. By using the matrix-profile based motif detection technique, described above, motifs representing event patterns can be automatically detected. In the depicted example, multiple motifs are automatically detected in the time-series data of the first graph 1002. Using the matrix-profiled based motif detection technique, a first motif 1006, second motif 1008, third motif 1010, fourth motif 1012, fifth motif 1014, sixth motif 1016, and seventh motif 1018 were detected. As shown, the first motif 1006 (shown in a first red ink) repeats several times in two sequences in the first half of the time series. The second motif 1008 (shown in purple ink) occurs early in the time series and partially again in the middle of the time series. The third motif 1010 (shown in a second red ink) repeats three times in the second half of the time series. The fourth motif 1012 (shown in a first green ink) occurs twice in the second half of the time series, following the third motif 1010. The fifth motif 1014 (shown in blue ink) occurs twice in the second half of the time series, following the fourth motif 1012. The sixth motif 1016 (shown in a second green ink) occurs twice in the second half of the time series, following the fifth motif 1014. Finally, the seventh motif 1018 (shown in cyan ink) occurs once at the end of the time series. The visually depicted motifs were detected using the matrix-profile based motif detection technique and may be associated with event nodes of the bipartite graph representation, as described herein.

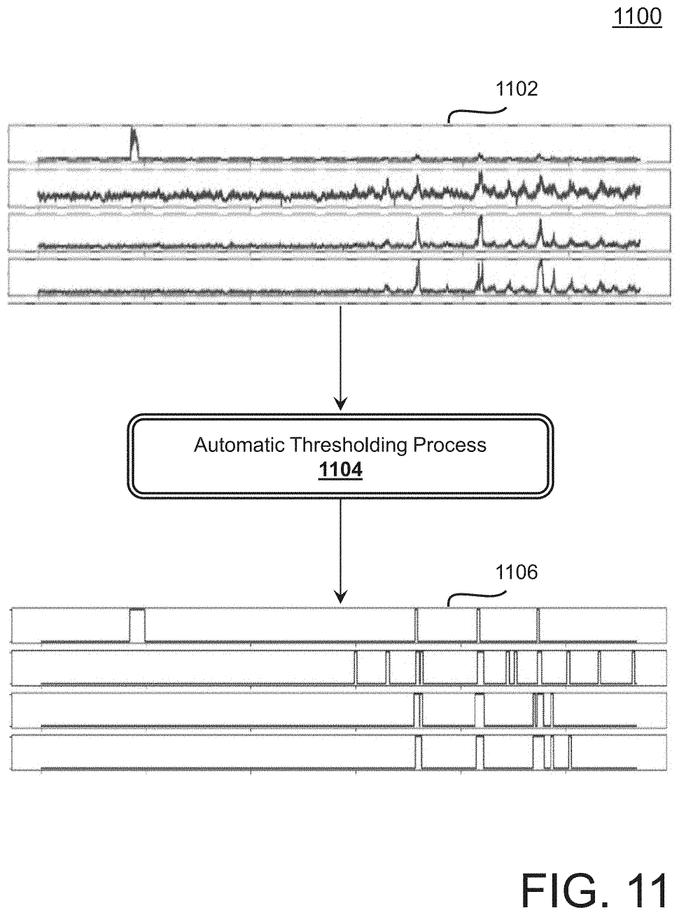

Referring now to FIG. 11, FIG. 11 is a diagram 1100 of a non-limiting embodiment or aspect of a process for event forecasting using a graph-based machine-learning model. Even for well-matched time series, pattern matching may still result in small residual errors. Therefore, to address lingering residual error, the described systems and method may use two general residual nodes as event nodes that indicate whether the residual error in a time series is larger than a threshold θ. One residual event node may indicate that the residual error is larger than threshold θ (e.g., event node l of FIG. 7), and one residual event node may indicate that the residual error is equal to or smaller than threshold θ (e.g., event node J of FIG. 7). The value of the threshold θ may be determined in a data-driven manner (e.g., with a SPOT algorithm), where the whole training dataset may be used for initialization and testing for on-going adaptation. All time series may share these two residual nodes. As shown in FIG. 11, a first residual value graph 1102 may be input to the automatic thresholding process 1104, described above. By comparing the residual score of each time interval t to the threshold θ, if the threshold θ is exceeded, the residual score may be converted to a binary value of 1 (indicating a residual event occurred at time interval t, e.g., associated with a first residual node). If the threshold θ is not exceeded, the residual score may be converted to a binary value of 0 (indicating a residual event did not occur at time interval t, e.g., associated with a second residual node). The threshold process 1104 may result in a binary-converted signal graph 1106 for each time interval t from the first residual value graph 1102.

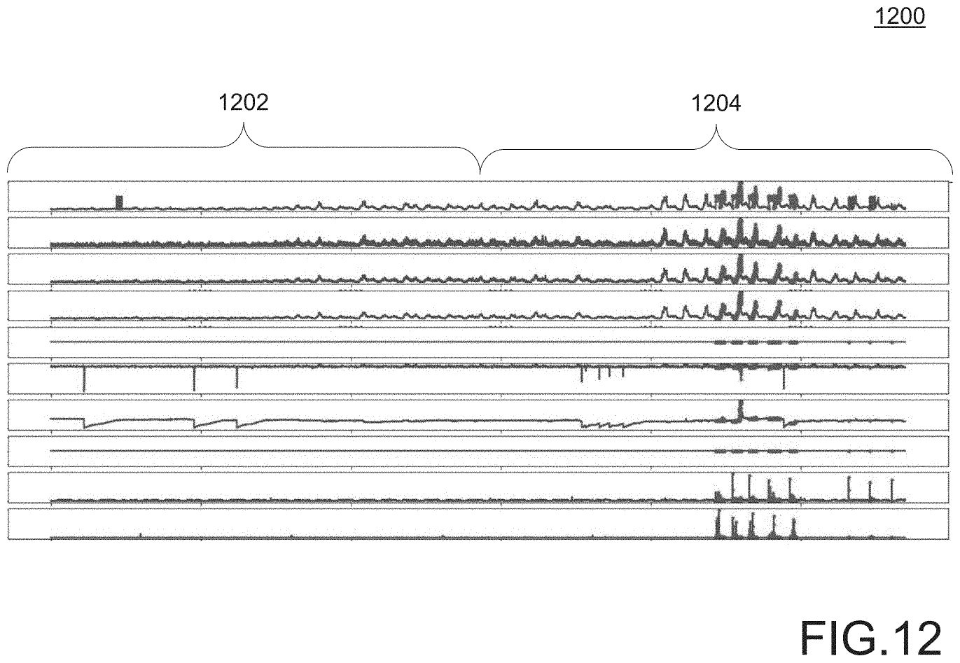

FIG. 12 is a diagram 1200 of an experimental application of a non-limiting embodiment or aspect a process for event forecasting using a graph-based machine-learning model. Depicted are the signal graphs of ten time series retrieved from the publically available Server Machine Dataset (SMD) (published in Robust Anomaly Detection for Multivariate Time Series through Stochastic Recurrent Neural Network, in the Proceedings of the 25th ACM SIGKDD International Conference on Knowledge Discovery & Data Mining (KDD) 2019, available at https://github.com/NetManAlOps/OmniAnomaly), which is incorporated by reference herein in its entirety. The first half 1202 of the time-series data was used as training data and is unlabeled for purposes of event (e.g., anomaly) detection. The second half 1204 of the time-series data was used as testing data and is labeled for purposes of event detection. Time-series data as sourced is shown in blue, and detected anomalous events in the time series are shown in red.

The foregoing described systems and methods were evaluated on the SMD dataset to verify the improvements to efficiency and accuracy of the machine-learning model. The present-disclosed solution was also compared to other approaches, including the deep autoencoding Gaussian mixture model (DAGMM) (an autoencoder-based anomaly detection model that does not take into account temporal information), the long short-term memory-variational autoencoder (LSTM-VAE) model and the LSTM-nonparametric dynamic thresholding (LSTM-NDT) model (two LSTM-based anomaly detection solutions), and OmniAnomaly and the multivariate time-series anomaly detection via graph attention network (MTAD-GAT) model (two stochastic variational autoencoder-based solutions).

Experimental results (shown in Table 1, below) indicated that the present-disclosed solution (titled “Event2Graph” in Table 1) outperforms most existing technical solutions, when considering the metrics of precision (e.g., true positives divided by the sum of true positives and false positives), recall (e.g., true positives divided by the sum of true positives and false negatives), and F1-score (e.g., two times precision times recall, divided by the sum of precision and recall).

TABLE 1

| Dataset | Method | Precision | Recall | F1 |
|---|---|---|---|---|
| SMD | DAGMM | 59.51 | 88.82 | 70.94 |
| | LSTM-VAE | 79.22 | 70.75 | 78.42 |
| | LSTM-NDT | 56.84 | 64.38 | 60.37 |
| | OmniAnomaly | 83.34 | 94.49 | 88.57 |
| | MTAD-GAT | — | — | — |
| | Event2Graph (max) | 85.35 | 83.71 | 83.47 |
| | Event2Graph (sum) | 88.61 | 83.38 | 84.93 |

Experimental results are shown for two implementations of the present-disclosed solution, one titled “Event2Graph (max)”, which represents use of Formula 12 (described above) for anomaly score calculation, and one titled “Event2Graph (sum)”, which represents use of Formula 13 (described above) for anomaly score calculation. Both implementations performed well and showed marked improvements to accuracy over other solutions.

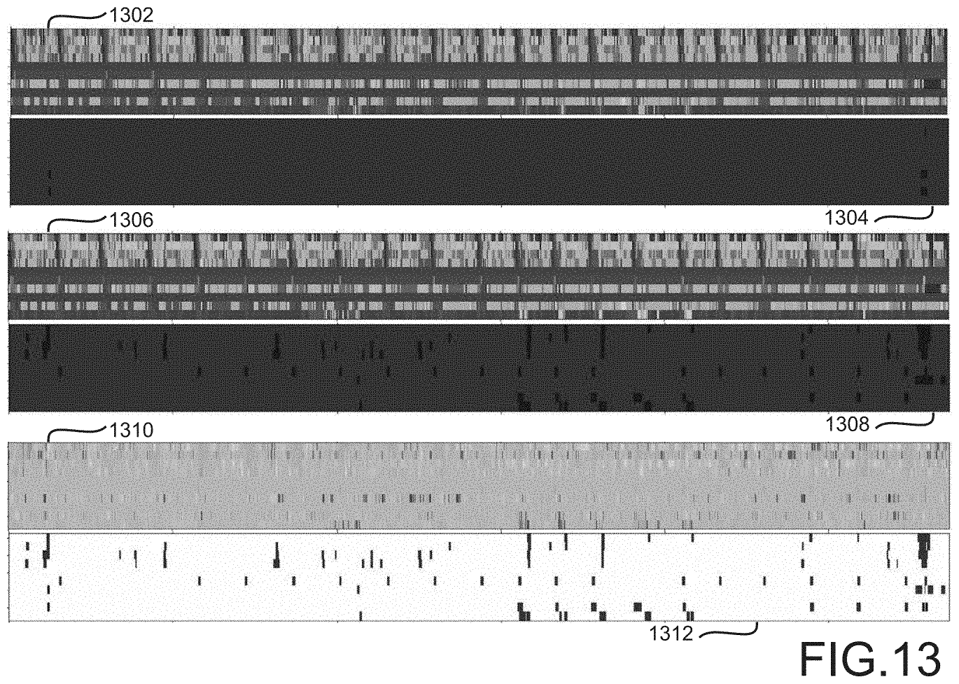

FIG. 13 is a diagram of an experimental application of a non-limiting embodiment or aspect a process for event forecasting using a graph-based machine-learning model. The diagram was produced from the experimental application of non-limiting embodiments or aspects of the disclosed methods on the SMD data, described above. The diagram includes three groups of graphs called event bars. Each event bar 1302, 1304, 1306, 1308, 1310, 1312 has an x-axis of time and includes a plurality of rows layered top-to-bottom in parallel, where each row corresponds to a time series variable (having a color value at an {x, y} position being the dependent value of a time series signal). A first group of event bars (event bars 1302, 1304) represents model prediction. A second group of event bars (event bars 1306, 1308) represents actual event detection (e.g., ground truth data). A third group of event bars (event bars 1310, 1312) represents the difference between the model prediction event bars and the actual event detection event bars. Moreover, for each group of event bars, there are two types of event bars. The first set of event bars, including event bars 1302, 1306, and 1310, are generated by time-series event pattern matching (e.g., corresponding to event nodes E, F, G shown in FIG. 7). The second set of event bars, including event bars 1304, 1308, and 1312, are generated by computation of residual error (e.g., corresponding to event nodes I, J shown in FIG. 7). The anomaly score may be generated based on the difference between the predicted events and the actual events, by using one of the score formulations described above. The colors of the event bars represent signal value and are assigned according to a gradient applied to the values of each time series' respective range. Dark blue represents one extrema value of the range (e.g., a minimum, such as 0 in a normalized range from 0 to 1, such as in event bars 1302 and 1306). Dark red represents the other extrema value of the range (e.g., a maximum, such as 1 in a normalized range from 0 to 1). Lime green represents the middle value of the range (e.g., 0, in a range of −1 to 1, such as in event bar 1310). The remaining colors of the visual rainbow spectrum are applied between 0 and 1 in a gradient (e.g., where green has a larger value than blue, yellow has a larger value than green, etc.).

As shown in FIG. 13, the present-disclosed solution was applied to the SMD data, where predicted values (e.g., event bars 1302, 1304) were compared to detected (e.g., actual) values (e.g., event bars 1306, 1308). The differences between the two groups of event bars were substantially 0 for most time series (as shown by the lime green in event bar 1310), but the differences (e.g., detected anomalies) between predicted and detected events are shown in event bar 1310 as departures from lime green in either direction of the spectrum. The residual score shown in event bar 1312 illustrates how the present-disclosed solution accounts for false positives in anomaly detection due to the abrupt changes of values in time series (e.g., accounted for in the residual score calculation), rather than by anomalous events. For example, where the residual score values of event bar 1312 coincide with anomalies shown in event bar 1310, it may be presumed that the detected anomalies were the result of abrupt changes in the time series, rather than by true anomalous events, and so the model may discount those detected anomalies and maintain higher model performance.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for event forecasting using a graph-based machine-learning model, the system comprising:
at least one processor programmed or configured to:
receive a dataset of data instances, wherein each data instance comprises a time series of data points;
detect a plurality of motifs representing a plurality of events in the dataset of data instances using a matrix profile-based motif detection technique;
generate a bipartite graph representation of the plurality of motifs in a time sequence, wherein, when generating the bipartite graph representation of the plurality of motifs, the at least one processor is programmed or configured to:
determine a plurality of features representing a plurality of nodes of the bipartite graph representation based on each event of the plurality of events represented by the plurality of motifs, and
determine a plurality of features representing a plurality of edges of the bipartite graph representation based on a time at which each event of the plurality of events represented by the plurality of motifs occurred in the time sequence; and
generate a machine-learning model based on the bipartite graph representation of the plurality of motifs in the time sequence, wherein the machine-learning model is configured to provide an output, and wherein the output comprises a prediction of whether an event will occur during a specified time interval.

2. The system of claim 1, wherein the at least one processor is further programmed or configured to:
perform an anomaly detection process based on the prediction of whether an event will occur during a specified time interval.

3. The system of claim 2, wherein the at least one processor is further programmed or configured to:
calculate an anomaly score for an entity based on the anomaly detection process.

4. The system of claim 1, wherein the machine-learning model is configured to provide the output based on an input, and wherein the input comprises one or more time series of data points.

5. The system of claim 1, wherein, when detecting the plurality of motifs representing the plurality of events in the dataset of data instances using the matrix profile-based motif detection technique, the at least one processor is programmed or configured to:
determine a matrix profile score for each data instance of the dataset of data instances; and
detect the plurality of motifs representing the plurality of events in the dataset of data instances based on the matrix profile score for each data instance of the dataset of data instances.

6. The system of claim 1, wherein the at least one processor is further programmed or configured to:
train the machine-learning model, wherein, when training the machine-learning model, the at least one processor is programmed or configured to:
determine whether the prediction of whether the event will occur during the specified time interval corresponds to ground truth data indicating whether the event did occur during the specified time interval; and
update weight parameters of the machine-learning model based on determining whether the prediction of whether the event will occur at the specified time interval corresponds to ground truth data indicating whether the event did occur at the specified time interval.

7. The system of claim 5, wherein, when detecting the plurality of motifs representing the plurality of events in the dataset of data instances using the matrix profile-based motif detection technique, the at least one processor is programmed or configured to:
detect each motif of the plurality of motifs according to a plurality of time intervals in which the plurality of motifs are located using the matrix profile-based motif detection technique; and
wherein, when generating the bipartite graph representation of the plurality of motifs in the time sequence, the at least one processor is programmed or configured to:
generate the bipartite graph representation of the plurality of motifs in the time sequence based on the plurality of time intervals in which the plurality of motifs are located.

8. The system of claim 1, wherein the plurality of nodes of the bipartite graph representation further comprise at least one residual node associated with a residual error.

9. The system of claim 8, wherein the at least one residual node comprises a first residual node and a second residual node, wherein the first residual node indicates the residual error is larger than a threshold, and wherein the second residual node indicates the residual error is equal to or less than the threshold.

10. The system of claim 9, wherein the at least one processor is further programmed or configured to calculate an anomaly score based on at least one of the following: an event forecasting score based on a probability value of at least one signal pattern in the bipartite graph representation, a residual score based on a frequency of change of at least one signal pattern in the bipartite graph representation, or any combination thereof.

11. A computer-implemented method for event forecasting using a graph-based machine-learning model, comprising:
receiving, with at least one processor, a dataset of data instances, wherein each data instance comprises a time series of data points;
detecting, with at least one processor, a plurality of motifs representing a plurality of events in the dataset of data instances using a matrix profile-based motif detection technique;
generating, with at least one processor, a bipartite graph representation of the plurality of motifs in a time sequence, wherein generating the bipartite graph representation of the plurality of motifs comprises:
determining, with at least one processor, a plurality of features representing a plurality of nodes of the bipartite graph representation based on each event of the plurality of events represented by the plurality of motifs, and
determining, with at least one processor, a plurality of features representing a plurality of edges of the bipartite graph representation based on a time at which each event of the plurality of events represented by the plurality of motifs occurred in the time sequence; and
generating, with at least one processor, a machine-learning model based on the bipartite graph representation of the plurality of motifs in the time sequence, wherein the machine-learning model is configured to provide an output, and wherein the output comprises a prediction of whether an event will occur during a specified time interval.

12. The method of claim 11, wherein detecting the plurality of motifs representing the plurality of events in the dataset of data instances using the matrix profile-based motif detection technique further comprises:
determining, with at least one processor, a matrix profile score for each data instance of the dataset of data instances; and
detecting, with at least one processor, the plurality of motifs representing the plurality of events in the dataset of data instances based on the matrix profile score for each data instance of the dataset of data instances.

13. The method of claim 12, wherein detecting the plurality of motifs representing the plurality of events in the dataset of data instances using the matrix profile-based motif detection technique comprises:
detecting, with at least one processor, each motif of the plurality of motifs according to a plurality of time intervals in which the plurality of motifs are located using the matrix profile-based motif detection technique; and
wherein generating the bipartite graph representation of the plurality of motifs in the time sequence comprises:
generating, with at least one processor, the bipartite graph representation of the plurality of motifs in the time sequence based on the plurality of time intervals in which the plurality of motifs are located.

14. The method of claim 11, wherein the plurality of nodes of the bipartite graph representation further comprise a first residual node that indicates a residual error is larger than a threshold and a second residual node that indicates the residual error is equal to or less than the threshold.

15. The method of claim 14, further comprising calculating, with at least one processor, an anomaly score based on at least one of the following: an event forecasting score based on a probability value of at least one signal pattern in the bipartite graph representation, a residual score based on a frequency of change of at least one signal pattern in the bipartite graph representation, or any combination thereof.

16. A computer program product for event forecasting using a graph-based machine-learning model, the computer program product comprising at least one non-transitory computer-readable medium including program instructions that, when executed by at least one processor, cause the at least one processor to:
receive a dataset of data instances, wherein each data instance comprises a time series of data points;
detect a plurality of motifs representing a plurality of events in the dataset of data instances using a matrix profile-based motif detection technique;
generate a bipartite graph representation of the plurality of motifs in a time sequence, wherein, when generating the bipartite graph representation of the plurality of motifs, the program instructions cause the at least one processor to:
determine a plurality of features representing a plurality of nodes of the bipartite graph representation based on each event of the plurality of events represented by the plurality of motifs, and
determine a plurality of features representing a plurality of edges of the bipartite graph representation based on a time at which each event of the plurality of events represented by the plurality of motifs occurred in the time sequence; and
generate a machine-learning model based on the bipartite graph representation of the plurality of motifs in the time sequence, wherein the machine-learning model is configured to provide an output, and wherein the output comprises a prediction of whether an event will occur during a specified time interval.

17. The computer program product of claim 16, wherein, when detecting the plurality of motifs representing the plurality of events in the dataset of data instances using the matrix profile-based motif detection technique, the program instructions cause the at least one processor to:
determine a matrix profile score for each data instance of the dataset of data instances; and
detect the plurality of motifs representing the plurality of events in the dataset of data instances based on the matrix profile score for each data instance of the dataset of data instances.

18. The computer program product of claim 17, wherein, when detecting the plurality of motifs representing the plurality of events in the dataset of data instances using the matrix profile-based motif detection technique, the program instructions cause the at least one processor to:
detect each motif of the plurality of motifs according to a plurality of time intervals in which the plurality of motifs are located using the matrix profile-based motif detection technique; and
wherein, when generating the bipartite graph representation of the plurality of motifs in the time sequence, the program instructions cause the at least one processor to:
generate the bipartite graph representation of the plurality of motifs in the time sequence based on the plurality of time intervals in which the plurality of motifs are located.

19. The computer program product of claim 16, wherein the plurality of nodes of the bipartite graph representation further comprise a first residual node that indicates a residual error is larger than a threshold and a second residual node that indicates the residual error is equal to or less than the threshold.

20. The computer program product of claim 19, wherein the program instructions further cause the at least one processor to calculate an anomaly score based on at least one of the following: an event forecasting score based on a probability value of at least one signal pattern in the bipartite graph representation, a residual score based on a frequency of change of at least one signal pattern in the bipartite graph representation, or any combination thereof.
